(19) United States
(12) Patent Application Publication
(10) Pub. No.: US 2025/0330823 A1
(43) Pub. Date: Oct. 23, 2025

(54) METHOD AND APPARATUS FOR SIDELINK UNLICENSED RESOURCE ALLOCATION

(71) Applicant: HUAWEI TECHNOLOGIES CO., LTD., Shenzhen (CN)

(72) Inventors: Brian Classon, Addison, TX (US); George Calcev, Addison, TX (US); Vipul Desai, Addison, TX (US)

(21) Appl. No.: 19/197,262

(22) Filed: May 2, 2025

Related U.S. Application Data
(63) Continuation of application No. PCT/US2023/078636, filed on Nov. 3, 2023.
(60) Provisional application No. 63/422,714, filed on Nov. 4, 2022.
(60) Provisional application No. 63/494,704, filed on Apr. 6, 2023.

(51) Int. Cl. H04W 16/14; H04W 74/00; H04W 74/0808; H04W 92/18

(52) U.S. Cl. CPC H04W 16/14; H04W 74/002; H04W 74/0808; H04W 92/18

(57) ABSTRACT

A method of transmitting sidelink synchronization signal block (S-SSB) implemented by a user equipment (UE). The method includes determining whether a time to transmit the S-SSB has been reached. The method also includes determining whether a first channel occupancy time is in progress. In response to a determination that the first channel occupancy time is not in progress, the method includes transmitting the S-SSB without the first channel occupancy time sharing channel access.

### CROSS-REFERENCE TO RELATED APPLICATIONS

This is a continuation of International Patent Application No. PCT/US2023/078636 filed on Nov. 3, 2023, which claims the benefit of U.S. Provisional Patent No. 63/422,714, filed Nov. 4, 2022, entitled “LTE AND NR PSFCH COEXISTENCE”, and U.S. Provisional Patent No. 63/494,704, filed Apr. 6, 2023, entitled “METHOD AND APPARATUS FOR SIDELINK UNLICENSED RESOURCE ALLOCATION”, which are hereby incorporated by reference in their entireties.

### BACKGROUND

The third-generation partnership project (3GPP) has been developing and standardizing several important features with fifth generation (5G) new radio access technology (NR). In Release-16, a work item for NR vehicle-to-everything (V2X) wireless communication with the goal of providing 5G-compatible high-speed reliable connectivity for vehicular communications was completed. This work item provided the basics of NR sidelink communication for applications such as safety systems and autonomous driving. High data rates, low latency, and high reliability were some of the key areas investigated and standardized. In Release-17, a work item Sidelink Enhancement was completed to enhance further the capabilities and performance of sidelink communication. There is a need for an inter-user equipment (UE) coordination mechanism, wherein one UE shares preferred or non-preferred resources with another UE to use in its resource selection or sends a conflict indication to another UE if there is a conflict on its reserved resources.

### SUMMARY

A first aspect relates to a method of transmitting sidelink synchronization signal block (S-SSB) implemented by a user equipment (UE). The method comprises: i) determining whether a time to transmit the S-SSB has been reached; ii) determining whether a first channel occupancy time is in progress; and iii) in response to a determination that the first channel occupancy time is not in progress, transmitting the S-SSB without the first channel occupancy time sharing channel access.

Optionally, in any of the preceding aspects, another implementation of the aspect includes wherein the method further comprises: i) in response to a determination that the first channel occupancy time is in progress, determining whether the UE is sharing the first channel occupancy time with a second UE; and ii) in response to a determination that the UE is not sharing the channel occupancy time with a second UE, transmitting the S-SSB without the first channel occupancy time sharing channel access.

Optionally, in any of the preceding aspects, another implementation of the aspect includes wherein the method further comprises, in response to a determination that the UE is sharing the first channel occupancy time with a second UE, determining whether the UE is allowed to transmit the S-SSB in the first channel occupancy time.

Optionally, in any of the preceding aspects, another implementation of the aspect includes wherein the method further comprises, in response to a determination that the UE is allowed to transmit the S-SSB in the first channel occupancy time, transmitting the S-SSB using the first channel occupancy time sharing channel access.

Optionally, in any of the preceding aspects, another implementation of the aspect includes wherein the method further comprises in response to a determination that the UE is not allowed to transmit the S-SSB in the first channel occupancy time, cancelling transmission of the S-SSB.

A second aspect relates to a user equipment (UE) comprising a transceiver configured to communicate with access nodes of a wireless network and to transmitting a sidelink synchronization signal block (S-SSB) to another user equipment in a coverage area of the wireless network. The UE includes one or more processors operably coupled to the transceiver; and a non-transitory memory storing programing instructions. When executed by the one or more processors, programming instructions cause the user equipment to: i) determine whether a time to transmit the S-SSB has been reached; ii) determine whether a first channel occupancy time is in progress; and iii) in response to a determination that the first channel occupancy time is not in progress, transmitting the S-SSB without the first channel occupancy time sharing channel access.

Optionally, in any of the preceding aspects, another implementation of the aspect includes wherein the programing instructions, when executed by the one or more processors, further cause the user equipment to: i) in response to a determination that the first channel occupancy time is in progress, determine whether the user equipment is sharing the first channel occupancy time with a second UE; and ii) in response to a determination that the UE is not sharing the channel occupancy time with a second UE, transmit the S-SSB without the first channel occupancy time sharing channel access.

Optionally, in any of the preceding aspects, another implementation of the aspect includes wherein the programing instructions, when executed by the one or more processors, further cause the user equipment to, in response to a determination that the UE is sharing the first channel occupancy time with a second UE, determine whether the UE is allowed to transmit the S-SSB in the first channel occupancy time.

Optionally, in any of the preceding aspects, another implementation of the aspect includes wherein the programing instructions, when executed by the one or more processors, further cause the user equipment to, in response to a determination that the UE is allowed to transmit the S-SSB in the first channel occupancy time, transmit by the UE the S-SSB using the first channel occupancy time sharing channel access.

Optionally, in any of the preceding aspects, another implementation of the aspect includes wherein the programing instructions, when executed by the one or more processors, further cause the user equipment to in response to a determination that the UE is not allowed to transmit the S-SSB in the first channel occupancy time, cancel transmission of the S-SSB.

A third aspect relates to a method of transmitting physical sidelink feedback channel (PSFCH) resource blocks implemented by a user equipment (UE). The method comprises: i) determining whether a first channel occupancy time is in progress; ii) in response to a determination that the first channel occupancy time is not in progress, using a PSFCH occasion configured by a data transmitter outside the first channel occupancy time access to transmit the PSFCH resource blocks; iii) in response to a determination that a first channel occupancy time is in progress, determining whether the UE is sharing the first channel occupancy time with a second UE; and iv) in response to a determination that the UE is not sharing the first channel occupancy time with a second UE, using a PSFCH occasion configured by the data transmitter outside the first channel occupancy time access to transmit the PSFCH resource blocks.

Optionally, in any of the preceding aspects, another implementation of the aspect includes wherein the method of claim 11 further includes: in response to a determination that the UE is sharing the first channel occupancy time with a second UE, using a PSFCH occasion configured by the data transmitter inside the first channel occupancy time access to transmit the PSFCH resource blocks.

Optionally, in any of the preceding aspects, another implementation of the aspect includes wherein the method further comprises: performing Listen Before Talk (LBT) channel sensing on at least one default PSFCH occasion.

Optionally, in any of the preceding aspects, another implementation of the aspect includes wherein the method further includes: i) determining whether the LBT channel sensing failed; and ii) in response to a determination that the LBT channel sensing did not fail, transmitting the PSFCH resource blocks.

Optionally, in any of the preceding aspects, another implementation of the aspect includes wherein the method further includes i) in response to a determination that the LBT channel sensing failed, performing LBT channel sensing on another PSFCH occasion; and ii) transmitting the PSFCH resource blocks after a successful LBT on additional PSFCH occasions.

A fourth aspect relates to a user equipment (UE), comprising: i) a transceiver configured to communicate with access nodes of a wireless network and to transmit a physical sidelink feedback channel (PSFCH) resource block to another UE in a coverage area of the wireless network; ii) one or more processors operably coupled to the transceiver; and iii) a non-transitory memory storing programing instructions. The programming instructions, when executed by the one or more processors, cause the UE to determine whether a first channel occupancy time is in progress. In response to a determination that a first channel occupancy time is not in progress, the UE uses a PSFCH occasion configured by a data transmitter outside the first channel occupancy time access to transmit the PSFCH resource blocks. The UE, in response to a determination that the first channel occupancy time is in progress, determines whether the UE is sharing the first channel occupancy time with a second UE. The UE, in response to a determination that the UE is not sharing the first channel occupancy time with a second UE, uses a PSFCH occasion configured by the data transmitter outside the first channel occupancy time access to transmit the PSFCH resource blocks.

Optionally, in any of the preceding aspects, another implementation of the aspect includes wherein the programing instructions, when executed by the one or more processors, further cause the user equipment to, in response to a determination that the UE is sharing the first channel occupancy time with the second UE, using a PSFCH occasion configured by the data transmitter inside the first channel occupancy time access to transmit the PSFCH resource blocks.

Optionally, in any of the preceding aspects, another implementation of the aspect includes wherein the programing instructions, when executed by the processor, further cause the user equipment to perform Listen Before Talk (LBT) channel sensing on at least one default PSFCH occasion.

Optionally, in any of the preceding aspects, another implementation of the aspect includes wherein the programing instructions, when executed by the processor, further cause the user equipment to determine whether the Listen Before Talk (LBT) channel sensing failed and, in response to a determination that the LBT channel sensing did not fail, to transmit the PSFCH resource blocks.

Optionally, in any of the preceding aspects, another implementation of the aspect includes wherein the programing instructions, when executed by the processor, further cause the user equipment to, in response to a determination that the LBT channel sensing failed, perform LBT channel sensing on another PSFCH occasion; and transmit the PSFCH resource blocks after a successful LBT on additional PSFCH occasions.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1A is a network topology diagram of a communication system according to an embodiment of the disclosure.

FIG. 1B is a diagram showing an in-coverage (IC) scenario according to an embodiment of the disclosure.

FIG. 1C is a diagram showing an out-of-coverage (OOC) scenario according to an embodiment of the disclosure.

FIG. 1D illustrates an example user equipment (UE) according to an embodiment of the disclosure.

FIG. 1E illustrates an example access node (or base station) according to an embodiment of the disclosure.

FIG. 2 is a diagram of an example resource pool in the time-frequency resource grid according to an embodiment.

FIG. 3A illustrates the frame structure for sidelink LTE mode 3 and mode 4 vehicle-to-vehicle (V2X) operation according to an embodiment.

FIG. 3B is a diagram of resources for PSCCH, PSSCH and PSFCH according to an embodiment of the disclosure.

FIG. 4 is a diagram showing an example timing of sensing and resource selection for Rel-16 NR sidelink transmission according to an embodiment.

FIG. 5 illustrates the structure of a sidelink synchronization signal block (S-SSB) according to an embodiment of the disclosure.

FIG. 6 illustrates a typical time slot structure including a physical sidelink feedback channel (PSFCH) occasion according to an embodiment of the disclosure.

FIG. 7 is a flowchart illustrating a sidelink synchronization signal block (S-SSB) transmission according to an embodiment of the disclosure.

FIG. 8 is a flowchart illustrating an example of PSFCH transmission flow according to an embodiment of the present disclosure.

FIG. 9 illustrates an example of multi-channel channel occupancy time (COT) and channel occupancy time (COT) sharing according to an embodiment of the disclosure.

FIG. 10 shows an example of a frame structure for sidelink New Radio (SL NR) mode 2 according to an embodiment of the disclosure.

FIG. 11 shows an example of a frame structure for sidelink New Radio (SL NR) mode 2 where PSFCH is configured according to an embodiment of the disclosure.

FIG. 12 illustrates the periodicity of PSFCH according to an embodiment of the disclosure.

FIG. 13 illustrates PSFCH coexistence according to an embodiment of the disclosure.

FIG. 14 is a flowchart depicting an example of NR SL UE coexistence in which data is transmitted according to an embodiment of the invention.

FIG. 15 is a flowchart depicting an example of NR SL UE coexistence in which data is received according to an embodiment of the invention.

FIG. 16 is a flowchart illustrating an example of PFSCH periodicity according to an embodiment of the present disclosure.

FIG. 17 is a flowchart illustrating an example of sidelink synchronization signal block (S-SSB) transmission flow according to an embodiment of the present disclosure.

### DETAILED DESCRIPTION

The present describes new techniques and signaling to enable sidelink positioning. Sidelink communication can either be in-coverage or out-of-coverage. With in-coverage (IC) operation, a central node (eNB, gNB) is present and can be used to manage the sidelink in mode 1, scheme 1. In mode 2, scheme 2, system operation is fully distributed and each user equipment (UE) selects resources on its own. In the present disclosure, some UEs may also be facilitated or assisted in selecting system resources. Note that in mode 2, UEs can be either in-coverage (IC) or out-of-coverage (OOC).

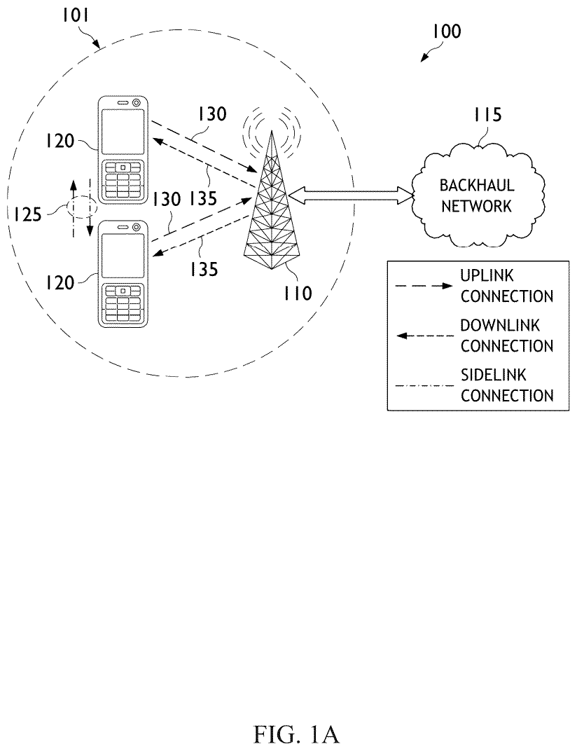

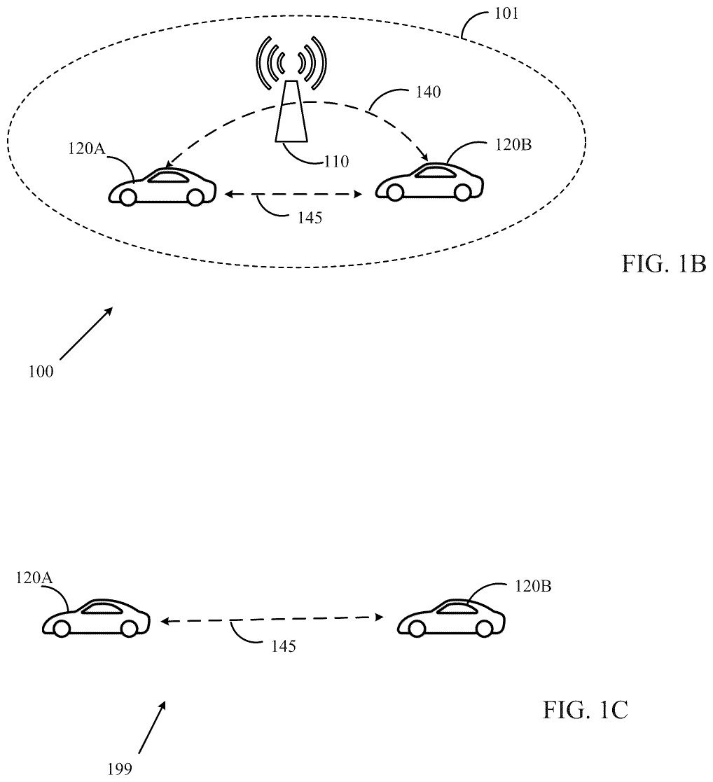

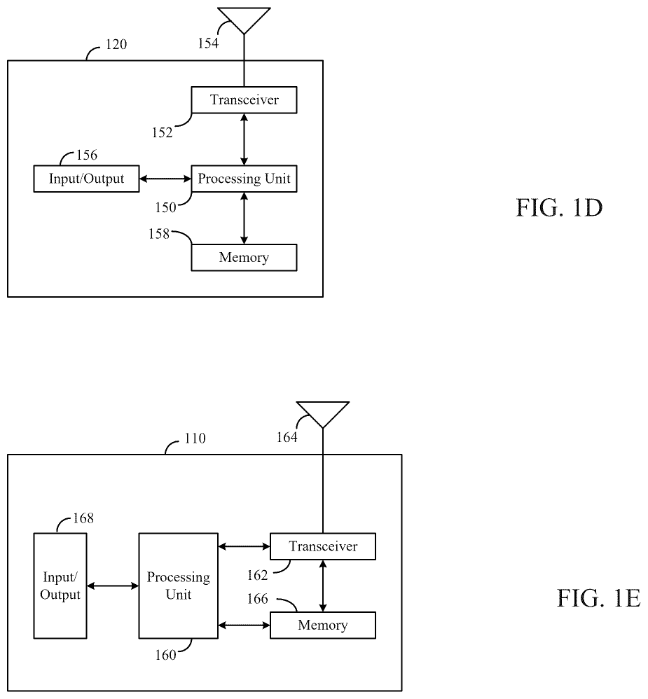

FIG. 1A is a network topology diagram of a communication system 100 according to an embodiment of the disclosure. In coverage area 101, communication system 100 includes an access node 110 serving user equipments (UEs), such as UEs 120. Access node 110 is coupled to a backhaul network 115 that provides connectivity to services and the Internet. In a first operating mode (IC operation), communications to and from a UE pass through access node 110. In a second operating mode (OOC operation), communications to and from a UE do not pass through access node 110. However, access node 110 typically allocates resources used by the UE to communicate when specific conditions are met. Communications between a UE pair in the second operating mode occur over sidelinks 125, which includes uni-directional communication links. Communications in the second operating mode may be referred to as “sidelink communications”. Communications between a UE and access node pair also occur over uni-directional communication links, wherein the communication links from UEs 120 to the access node 110 are referred to as “uplinks 130” and the communication links from the access node 110 to the UEs 120 are referred to as “downlinks 135”.

Access nodes 110 may also be commonly referred to as Node Bs, evolved Node Bs (eNBs), next generation (NG) Node Bs (gNBs), master eNBs (MeNBs), secondary eNBs (SeNBs), master gNBs (MgNBs), secondary gNBs (SgNBs), network controllers, control nodes, base stations, access points, transmission points (TPs), transmission-reception points (TRPs), cells, carriers, macro cells, femtocells, pico cells, and so on. UEs may also be commonly referred to as mobile stations, mobiles, terminals, users, subscribers, stations, and the like. Access nodes may provide wireless access in accordance with one or more wireless communication protocols, for example, the Third Generation Partnership Project (3GPP) long term evolution (LTE), LTE advanced (LTE-A), 5G, 5G LTE, 5G NR, sixth generation (6G), High Speed Packet Access (HSPA), the IEEE 802.11 family of standards, such as 802.11a/b/g/n/ac/ad/ax/ay/be, and others. While it is understood that communication systems may employ multiple access nodes capable of communicating with a number of UEs, only one access node 110 and two UEs 120 are illustrated for simplicity.

The sidelink communication can either be in-coverage or out-of-coverage. For an in-coverage (IC) operation, a central node (e.g., access node, eNB, gNB, etc.) may be present and used to manage sidelinks. For an out-of-coverage (OOC) operation, the system operation is fully distributed and UEs select resources on their own.

FIG. 1B is a diagram showing an in-coverage (IC) scenario 100 according to an embodiment of the disclosure. In the IC scenario 100, access node 110 is configured to manage sidelink communications 145 between UE 120A and UE 120B in the coverage area 101 of the access node 110. UEs 120A and 120B may be considered as “mode 1” UEs. In a first operating mode (IC operation), communications 140 to and from a UE pass through access node 110.

FIG. 1C is a diagram showing an out-of-coverage (OOC) scenario 199 according to an embodiment of the disclosure. In the OOC scenario 199, UEs 120A and 120B perform sidelink communications 145 with each other without management of a central node and select resources on their own for the sidelink communications 145. UE 120A and UE 120B may be considered as “mode 2” UEs. UE 120A and UE 120B can operate in mode 2 while in-coverage. In an embodiment of the present disclosure, some UEs may be facilitated or assisted to select their resources for sidelink communications.

FIGS. 1D and 1E illustrate example devices that may implement the methods and teachings according to this disclosure. In particular, FIG. 1D illustrates an example user equipment (UE) 120 according to an embodiment of the disclosure. FIG. 1E illustrates an example access node (or base station) 110 according to an embodiment of the disclosure. These components could be used in the communication system 100 or in any other suitable system

As shown in FIG. 1D, the UE 120 includes at least one processing unit 150. The processing unit 150 implements various processing operations of the UE 120. For example, the processing unit 150 may perform signal coding, data processing, power control, input/output processing, or any other functionality enabling the UE 120 to operate in the communication system 100. The processing unit 150 also supports the methods and teachings described in more detail herein. Each processing unit 150 includes any suitable processing or computing device configured to perform one or more operations. Each processing unit 150 may, for example, include a microprocessor, microcontroller, digital signal processor, field programmable gate array, or application specific integrated circuit.

The UE 120 also includes at least one transceiver 152. The transceiver 152 is configured to modulate data or other content for transmission by at least one antenna 154. The transceiver 152 is also configured to demodulate data or other content received by the at least one antenna 154. Each transceiver 152 includes any suitable structure for generating signals for wireless or wired transmission or processing signals received wirelessly or by wire. Each antenna 154 includes any suitable structure for transmitting or receiving wireless or wired signals. One or multiple transceivers 152 could be used in the UE 120, and one or multiple antennas 154 could be used in the UE 120. Although shown as a single functional unit, a transceiver 152 could also be implemented using at least one transmitter and at least one separate receiver. In some embodiments, transceiver 152 in UE 120 may comprise a dual transceiver architecture in which a first LTE transceiver module communicates with other devices (e.g., access nodes, UEs, etc.) using LTE protocol and a second new radio (NR) transceiver module communicates with other devices using, for example, fifth generation (5G) NR protocol.

The UE 120 further includes one or more input/output (I/O) devices 156 or interfaces (such as a wired interface to the Internet). The I/O devices 156 facilitate interaction with a user or other devices (network communications) in the network. Each I/O device 156 includes any suitable structure for providing information to or receiving information from a user, such as a speaker, microphone, keypad, keyboard, display, or touch screen, including network interface communications.

In addition, the UE 120 includes at least one memory 158. The memory 158 stores instructions and data used, generated, or collected by the UE 120. The memory 158 comprises a non-transitory computer-readable storage medium that may store a computer program product for use by the user equipment. The computer program product stores programing instructions that, when executed by the processor 150, cause the user equipment (UE) to execute any of the operations or methods described in this disclosure. For example, the memory 158 could store software or firmware instructions executed by the processing unit(s) 150 and data used to reduce or eliminate interference in incoming signals. Each memory 158 includes any suitable volatile or non-volatile storage and retrieval device(s). Any suitable memory may be used, such as random-access memory (RAM), read-only memory (ROM), hard disk, optical disc, subscriber identity module (SIM) card, memory stick, secure digital (SD) memory card, and the like.

As shown in FIG. 1E, the access node 110 includes at least one processing unit 160, at least one transceiver 162, which includes functionality for a transmitter and a receiver, one or more antennas 164, at least one memory 166, and one or more input/output (I/O) devices (or interfaces) 168. A scheduler, which would be understood by one skilled in the art, is coupled to the processing unit 160. The scheduler could be included within or operated separately from the access node 110. The processing unit 160 implements various processing operations of the access node 110, such as signal coding, data processing, power control, input/output processing, or any other functionality. The processing unit 160 can also support the methods and teachings described in more detail herein. Each processing unit 160 includes any suitable processing or computing device configured to perform one or more operations. Each processing unit 160 could, for example, include a microprocessor, microcontroller, digital signal processor, field programmable gate array, or application specific integrated circuit.

Each transceiver 162 includes any suitable structure for generating signals for wireless or wired transmission to one or more UEs or other devices. Each transceiver 162 further includes any suitable structure for processing signals received wirelessly or by wire from one or more UEs or other devices. Although shown combined as a transceiver 162, a transmitter and a receiver could be separate components. Each antenna 164 includes any suitable structure for transmitting or receiving wireless or wired signals. While a common antenna 164 is shown here as being coupled to the transceiver 162, one or more antennas 164 could be coupled to the transceiver(s) 162, allowing separate antennas 164 to be coupled to the transmitter and the receiver if equipped as separate components. In some embodiments, transceiver 162 in access node 110 may comprise a dual transceiver architecture in which a first LTE transceiver module communicates with other devices (e.g., UEs) using LTE protocol and a second new radio (NR) transceiver module communicates with other devices using, for example, fifth generation (5G) NR protocol.

Each memory 166 includes any suitable volatile or non-volatile storage and retrieval device(s). Each input/output device 168 facilitates interaction with a user or other devices (network communications) in the network. The memory 166 comprises a non-transitory computer-readable storage medium that may store a computer program product for use by the user equipment. The computer program product stores programing instructions that, when executed by the processor 160, cause the access node 110 to execute any of the operations or methods described in this disclosure. Each input/output device 168 includes any suitable structure for providing information to or receiving/providing information from a user, including network interface communications.

For the purpose of sidelink communications, resource pools are provided for LTE sidelink and may be reused for NR sidelink. A resource pool is a set of resources that may be used for sidelink communication. Resources in a resource pool may be configured for different channels and signals, such as control channels, shared channels, feedback channels, broadcast channels (e.g., a master information block), synchronization signals, reference signals, and so on. 3GPP TS 38.331, “NR; Radio Resource Control (RRC); Protocol specification,” V16.4.1, Mar. 30, 3021, which is herein incorporated by reference, defines rules on how the resources in the resource pool are shared and used for a particular configuration of the resource pool. A UE performing sidelink transmissions may select a resource from a resource pool configured for sidelink communication and transmit signals in the resource on a sidelink.

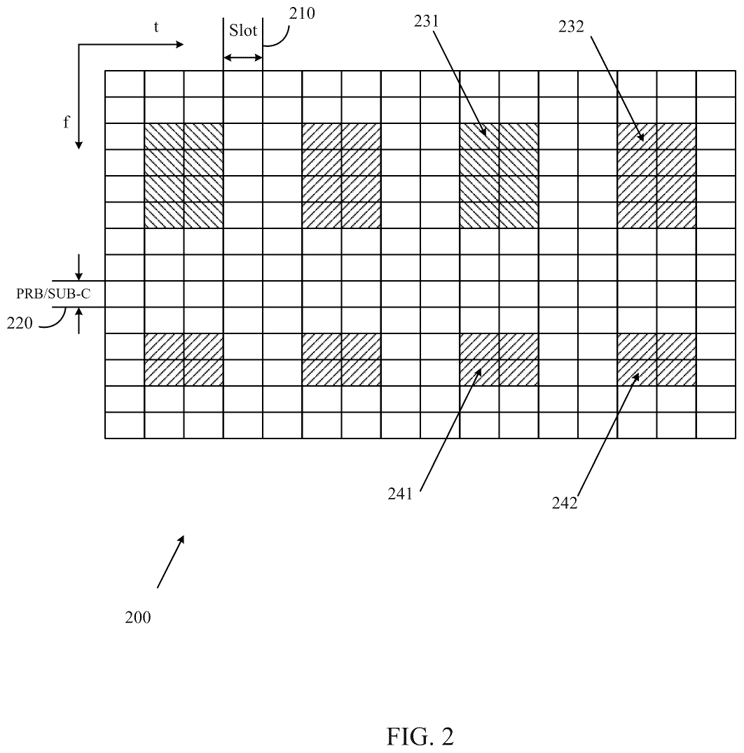

FIG. 2 is a diagram of a resource pool 200 in the time-frequency resource grid according to an embodiment. A resource pool 200 for sidelink communication may be configured in units of slots 210 in the time domain (horizontal axis) and physical resource blocks (PRBs) 220 or sub-channels (SUB-C) 220 in the frequency domain (vertical axis). A sub-channel 220 may include one or more PRBs 220. FIG. 2 shows a resource pool 200 including a plurality of resources 231, 232, 241, 242 (shaded rectangles) in different slots 210 and PRBs/sub-channels 220.

According to 3GPP TS 38.211, “NR; Physical channels and modulation,” V16.5.0, Mar. 30, 2031, which is herein incorporated by reference in its entirety, for NR mobile broadband (MBB), each physical resource block (PRB) in the grid is defined as including a slot of 14 consecutive orthogonal frequency division multiplexing (OFDM) symbols in the time domain and 12 consecutive subcarriers in the frequency domain (i.e., each resource block includes 12×14 resource elements (REs). When used as a frequency-domain unit, a PRB may be 12 consecutive subcarriers. There are 14 symbols in a slot when a normal cyclic prefix is used and 12 symbols in a slot when an extended cyclic prefix is used. The duration of a symbol is inversely proportional to the subcarrier spacing (SCS). For a {15, 30, 60, 120} kHz SCS, the duration of a slot is {1, 0.5, 0.25, 0.125} msec., respectively.

A PRB may be allocated for communicating a channel and/or a signal, (e.g., a control channel, a shared channel, a feedback channel, a reference signal, or a combination thereof). In addition, some REs of a PRB may be reserved. A similar time-frequency resource structure may be used on the sidelink as well. A communication resource (e.g., for sidelink communication) may be a PRB, a set of PRBs, a code (if code division multiple access (CDMA) is used, similarly to that used for a physical uplink control channel (PUCCH)), a physical sequence, a set of REs, or a combination thereof.

As used herein, a UE participating in sidelink communication may be referred to as a “source UE”, a “transmit UE”, a “transmitting UE”, or a “Tx UE” when the UE is configured to transmit signals on a sidelink to another UE. A UE participating in sidelink communication may be referred to as a “destination UE”, a “receive UE”, a “receiving UE”, an “Rx UE”, or a “recipient UE”, when the UE is configured to receive signals on a sidelink from another UE. Two UEs communicating with each other on a sidelink may also be referred to as a “UE pair” in sidelink communication.

A physical sidelink shared channel (PSSCH) carries sidelink data between UEs. Sidelink transmission may include a one-to-many scheme, meaning that the data is to be received by multiple UEs that belong to a group. A PSSCH is a dedicated wireless communication channel used for direct device-to-device (D2D) communication in cellular networks like 4G LTE and 5G. It facilitates proximity-based services by allowing nearby devices (e.g., UEs) to communicate without routing through an access node or base station. A PSSCH has specialized resource allocation, control signaling, and security measures to support low-latency and efficient D2D communication, making it essential for applications like public safety, vehicle-to-vehicle (V2V) communication, and collaborative sensing. The time and frequency resources of the PSSCH may be referred to as “resource assignment” or “allocation” and may be indicated in the time resource assignment field and/or a frequency resource assignment field (i.e., resource locations).

A physical sidelink control channel (PSCCH) carries sidelink control information (SCI). SCI Format 1 consists of PSSCH transmission information and is transmitted in two consecutive resource blocks (RBs). A source UE uses the SCI to schedule transmission of data on a physical sidelink shared channel (PSSCH) or reserve a resource for the transmission of the data on the PSSCH. The SCI may convey the time and frequency resources of the PSSCH, and/or parameters for hybrid automatic repeat request (HARQ) process, such as a redundancy version, a process id (or ID), a new data indicator, and resources for a physical sidelink feedback channel (PFSCH).

The physical sidelink feedback channel (PSFCH) carries Hybrid-ARQ feedback for sidelink transmissions received on the PSSCH. The basic structure of the PSFCH is the same as PUCCH format 0. The PSFCH may carry an indication (e.g., a HARQ acknowledgement (HARQ-ACK) or negative acknowledgement (HARQ-NACK)) indicating whether a destination UE decoded the payload carried on the PSSCH correctly. The SCI may also carry a bit field indicating or identifying the source UE. In addition, the SCI may carry a bit field indicating or identifying the destination UE. The SCI may further include other fields to carry information such as a modulation coding scheme used to encode the payload and modulate the coded payload bits, a demodulation reference signal (DMRS) pattern, antenna ports, a priority of the payload (transmission), and so on. A sensing UE performs sensing on a sidelink, for example, receiving a PSCCH sent by another UE, and decoding SCI carried in the PSCCH to obtain information of resources reserved by another UE, and determining resources for sidelink transmissions of the sensing UE.

In mode 1 operation, the time-frequency resources used by the UE-to-UE link are allocated by an access node (or base station). In mode 2 operation, a common time-frequency resource is autonomously shared between the UEs without the intervention of the access node. The 3rd Generation Partnership Project (3GPP) specified a standard for vehicle to everything (V2X) communications based on the LTE radio interface. This defines the PC5 interface for V2X sidelink or direct communications and introduces two different modes for the management of the radio resources of the PC5 interface—Mode 3 and Mode 4.

Mode 3 is a centralized mode where the cellular network selects the radio resources that vehicles utilize for direct or sidelink V2V communications (i.e. without using the Uu interface). Mode 3 may improve quality of service (QOS) and scalability since the cellular network has complete knowledge of the network status and the demand for resources from different vehicles. Mode 3 can then improve the resource selection and reduce interference among vehicles. Unlike for Mode 4, 3GPP does not specify a concrete scheduling scheme for Mode 3.

Mode 4 is a distributed mode that UEs (e.g., vehicles) may use to select autonomously their radio resources using a sensing-based semi-persistent scheduling (SPS) scheme. Mode 4 may operate without cellular coverage but its communications performance may be affected by a non-optimal radio resource selection based only on local sensing.

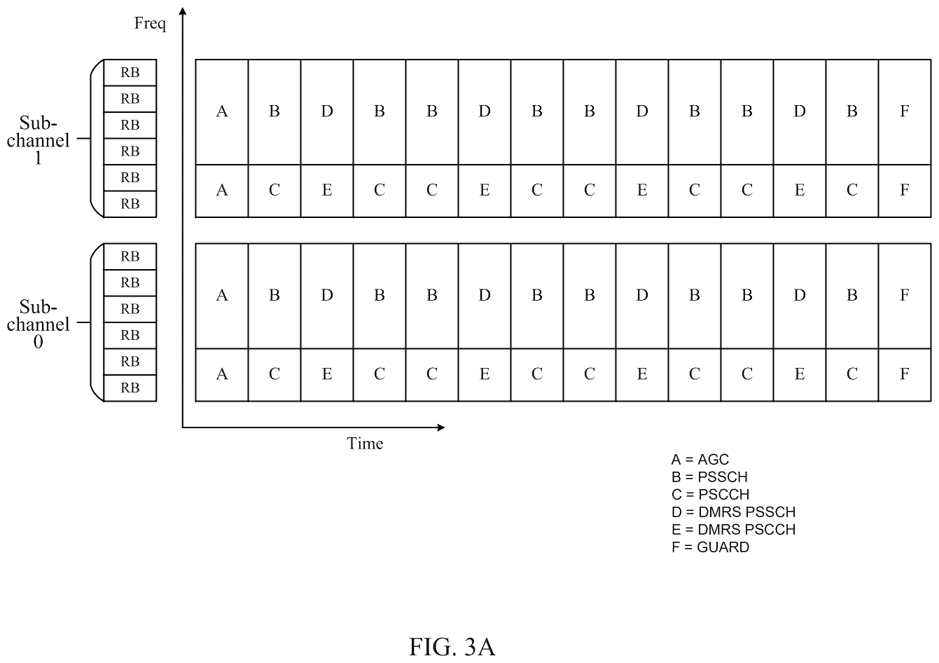

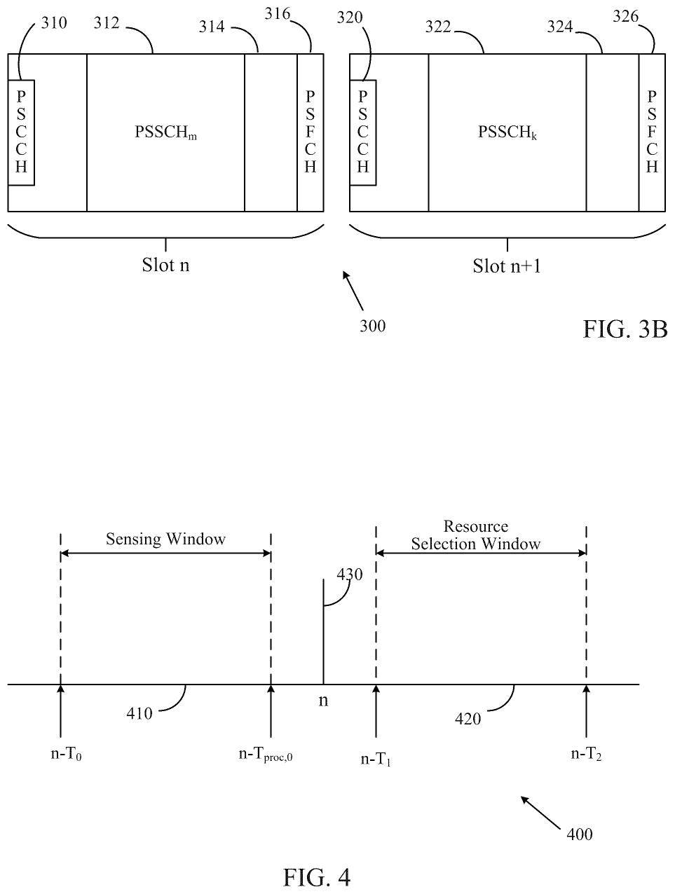

LTE—FIG. 3A illustrates the frame structure for sidelink LTE mode 3 and mode 4 vehicle-to-vehicle (V2V) operation according to an embodiment. Two subchannels are shown: subchannel 0 and subchannel 1. Each subchannel includes 6 RBs. Some examples of subchannel sizes are: 4, 5, 6, 8, 9, 10, 12, 15, 16, 18, 20, 25, 30, 48, 50, 72, 75, 96, and 100 RBs. In FIG. 3A, a 14 symbol subframe has symbols for automatic gain control (AGC), PSSCH, DMRS PSSCH, PSCCH, DMRS PSCCH, and guard, as identified by the letters A-F in the legend in FIG. 3A.

The data (PSSCH) and control (PSCCH) information are multiplexed in the frequency domain. In LTE, the starting resource location for PSCCH is related to the sub-channel index. By configuration, a Tx pool for V2V is divided into “m” sub-channels. The transmitting vehicle selects one of the m sub-channels or is signaled by the eNB to use a particular sub-channel in a DCI message The PSSCH is placed after the PSCCH such that the PSCCH occupies a lower frequency location than the PSSCH. The PSCCH for V2V occupies two PRBs.

An LTE device can measure the RSSI over symbols. Typically, no measurements are performed over the guard symbols and AGC symbols. A receiving LTE UE can examine the received SCI to determine the periodicity and priority of the received transmission. The periodicity, priority, and measurements may be used in resource selection by the LTE device for its transmission.

FIG. 3B is a diagram 300 of resources for PSCCH, PSSCH, and PSFCH according to an embodiment of the disclosure. FIG. 3B shows the resources in slot n and slot n+1. Slot n includes a resource region 310 for PSCCH, a resource region 312 for PSSCH (or PSSCHₘ), a reserve region 314, and a resource region 316 for PSFCH. Slot n+1 includes a resource region 320 for PSCCH, a resource region 322 for PSSCH (or PSSCHₖ), a reserve region 324, and a resource region 326 for PSFCH.

In New Radio (NR), there are two stages for the SCI: a first stage and a second stage. The first stage SCI may indicate the resources for the second stage SCI. A first stage SCI may be transmitted in the PSCCH. A second stage SCI may be transmitted in the PSSCH. The SCI may have the following formats: SCI format 1-A, SCI format 2-A and SCI format 2-B.

In Rel-16 NR vehicle-to-everything (V2X) sidelink communications, mode 2 UEs transmit and receive information without network management. The UEs allocate resources for themselves from a resource pool for sidelink transmissions. The resource allocation relies on a sensing and reservation process as shown in FIG. 4.

FIG. 4 is a diagram 400 showing an example timing of sensing and resource selection for Rel-16 NR sidelink transmission according to an embodiment. The timing of sensing and resource selection is usually referred as “full sensing”. The diagram 400 includes a sensing window 410 during which a UE may monitor availability of sidelink resources and a resource selection window 420 during which the UE may select an available sidelink resource.

During a sensing procedure, a UE that is to perform sidelink transmission (also referred to as a monitoring UE or sensing UE, or transmitting UE as the UE is to transmit SL traffic) detects an SCI transmitted in each slot in the sensing window 410 and measures received signal receive power (RSRP) of the resource indicated in the SCI. The monitoring UE may also receive transmissions of data during the sensing window 410. Thus, the monitoring UE is also a receiving UE. For resource reservations for sidelink transmissions of periodic traffic, if a UE occupies a resource on slot sₘ (e.g., a UE k occupies resource on slot sₘ), it will also occupy resource(s) on slot sₘ+q*RRIₖ, where q is an integer, and RRIₖ is a resource reservation interval of the UE k that the sensing UE detected. The monitoring UE may detect the SCI of the UE k and the resource occupied by the UE k. Detecting the SCI by the monitoring UE may, for example, include the steps of receiving and decoding a PSCCH and processing the SCI within the PSCCH.

For aperiodic or dynamic transmissions, a transmitting UE (e.g., the UE k) in sidelink communications may reserve multiple resources and indicate the next resource in its SCI. Therefore, based on the sensing result of the monitoring UE (e.g., based on detection of SCI of UE k), the monitoring UE can determine which resources may be occupied in the future and can avoid selecting those resources for its own sidelink transmission. The monitoring UE may determine whether a resource is occupied based on measured RSRP on the resource during the sensing period (the sensing window 410). For example, if the measured RSRP on the occupied resource during the sensing period is above a RSRP threshold, the monitoring UE may avoid the occupied resource, as in the resource exclusion procedure described in TS 38.214.

When resource selection is triggered on slot “n” 430, based on sensing results in the sensing window 410 (i.e., on slots [n-T₀, n-T_{proc,0}]), the monitoring or transmitting UE may select the sidelink resources in a resource pool during the resource selection window 420 in a resource pool (i.e., on slots [n+T₁, n+T₂]). The variables are defined as follow: i) To is the number of slots with the value determined by resource pool configuration; ii) T_{proc,0} is the time required for a UE to complete the sensing process; iii) T₁ is the processing time required for identification of candidate resources and resource selection T₁≤T_{proc,1}; iv) T₂ is the last slot of resource pool for resource selection which is left to UE implementation, but in the range of [T₂ₘᵢₙ, PDB] where T₂ₘᵢₙ is the minimum value of T₂ and PDB denotes “packet delay budget”, the remaining time for UE transmitting the data packet; and v) T_{proc,1} is the maximum time required for a UE to identify candidate resources and select new sidelink resources.

To select a resource, the transmitting UE (which senses the resources for sidelink transmission) may identify the candidate resources (or available resources) by excluding the occupied resources that have measured RSRP over a configured RSRP threshold. The transmitting UE may compare a ratio (also referred to as “available resource ratio”) of the available resources over all resources in the selection window 420. If the available resource ratio is greater than a threshold X %, then the transmitting UE may select a resource randomly among the candidate resources. If the available resource ratio is not greater than X %, the transmitting UE may increase the RSRP threshold by 3 dB and check the available resource ratio until the available resource ratio is equal to or greater than X %. The value “X” may be chosen from a list, sl-TxPercentageList, and its value is determined by data priority. As specified in TS 38.214, sl-TxPercentageList, the internal parameter X for a given prio_{Tx} is defined as sl-TxPercentageList (prior_{Tx}) converted from percentage to a ratio.

As explained above, the NR sidelink control information (SCI) may be transmitted in two stages, namely, a first stage SCI Format 1-A and a second stage SCI Formats 2-A, B or C. The first stage indicates the resources for the second stage SCI. According to TS 38.212, SCI format 1-A is used for the scheduling of PSSCH and 2nd-stage-SCI on PSSCH.

SCI format 1-A—

The following information is transmitted by means of the SCI format 1-A:
i) Priority—Three (3) bits, as defined in clause 5.4.3.3 of TS 23.287;
ii) Frequency Resource Assignment—

$$⌈ {log}_{2} ( \frac{{N}_{subChannel}^{SL} ( {N}_{subChannel}^{SL} + 1 )}{2} ) ⌉ bits \qquad a )$$

when the value of the higher layer parameter sl-MaxNumPerReserve is configured to 2; otherwise,

$$⌈ {log}_{2} ( \frac{{N}_{subChannel}^{SL} ( {N}_{subChannel}^{SL} + 1 ) ( 2 {N}_{subChannel}^{SL} + 1 )}{6} ) ⌉ bits \qquad b )$$

when the value of the higher layer parameter sl-MaxNumPerReserve is configured to 3, as defined in clause 8.1.2.2 of TS 38.214;
iii) Time Resource Assignment—
   a) Five (5) bits when the value of the higher layer parameter sl-MaxNumPerReserve is configured to 2; otherwise,
   b) Nine (9) bits when the value of the higher layer parameter sl-MaxNumPerReserve is configured to 3, as defined in clause 8.1.2.1 of TS 38.214.
iv) Resource Reservation Period—
   a) ┌log₂ N_{rsv_period} ┐ bits as defined in clause 8.1.4 of TS 38.214, where N_{rsv_period} is the number of entries in the higher layer parameter sl-ResourceReservePeriodList, if higher layer parameter sl-MultiReserveResource is configured;
   b) Zero (0) bits otherwise.
v) DMRS pattern—
   a) ┌log₂ Nₚₐₜₜₑᵣₙ┐ bits as defined in clause 8.4.1.1.2 of TS 38.211, where Nₚₐₜₜₑᵣₙ is the number of DMRS patterns configured by higher layer parameter sl-PSSCH-DMRS-TimePatternList;
   b) Zero (0) bits if sl-PSSCH-DMRS-TimePatternList is not configured.
vi) 2nd-stage SCI format—Two (2) bits as defined in Table 8.3.1.1-1.
vii) Beta_offset indicator—Two (2) bits as provided by higher layer parameter sl BetaOffsets2ndSCI and Table 8.3.1.1-2.
viii) Number of DMRS port-One (1) bit as defined in Table 8.3.1.1-3.
ix) Modulation and coding scheme—Five (5) bits as defined in clause 8.1.3 of TS 38.214.
x) Additional MCS table indicator—As defined in clause 8.1.3.1 of TS 38.214:
   a) One (1) bit if one MCS table is configured by higher layer parameter sl-Additional-MCS-Table;
   b) Two (2) bits if two MCS tables are configured by higher layer parameter sl-Additional-MCS-Table;
   c) Zero (0) bit otherwise.
xi) PSFCH overhead indication—1 bit as defined clause 8.1.3.2 of TS 38.214 if higher layer parameter sl-PSFCH-Period=2 or 4; 0 bit otherwise.
xii) Reserved-a few bits as determined by higher layer parameter sl-NumReservedBits, with value set to zero (0).
   SCI format 2-A—

SCI format 2-A from TS 38.212 is used for the decoding of PSSCH with HARQ operation when HARQ-ACK information includes ACK or NACK, or when there is no feedback of HARQ-ACK information. The following information is transmitted by the SCI format 2-A:
i) HARQ process number—┌log₂ N_{process}┐ bits as defined in clause 16.4 of TS 38.213;
ii) New data indicator—One (1) bit as defined in clause 16.4 of TS 38.213;
iii) Redundancy version—Two (2) bits as defined in clause 16.4 of TS 38.214;
iv) Source ID-Eight (8) bits as defined in clause 8.1 of TS 38.214;
v) Destination ID-Sixteen (16) bits as defined in clause 8.1 of TS 38.214;
vi) HARQ feedback enabled/disabled indicator-One (1) bit as defined in clause 16.3 of TS 38.213;
vii) Cast type indicator—Two (2) bits as defined in Table 8.4.1.1-1, shown below;
viii) CSI request—(1) bit as defined in clause 8.2.1 of TS 38.214.

TABLE 8.4.1.1-1
Cast type indicator

| Value of Cast | |
|---|---|
| type indicator | Cast type |
| 00 | Broadcast |
| 01 | Groupcast |
| 10 | Unicast |
| 11 | Reserved |

According to TS 38.212, SCI format 2-B is used for the decoding of PSSCH, with HARQ operation when HARQ-ACK information includes only NACK, or when there is no feedback of HARQ-ACK information. The following information is transmitted by means of the SCI format 2-B:
i) HARQ process number—┌log₂ N_{process}┐ bits as defined in clause 16.4 of TS 38.213;
ii) New data indicator—One (1) bit as defined in clause 16.4 of TS 38.213;
iii) Redundancy version—Two (2) bits as defined in clause 16.4 of TS 38.214;
iv) Source ID-Eight (8) bits as defined in clause 8.1 of TS 38.214;
v) Destination ID-Sixteen (16) bits as defined in clause 8.1 of TS 38.214;
vi) HARQ feedback enabled/disabled indicator—One (1) bit as defined in clause 16.3 of TS 38.213;
vii) Zone ID-Twelve (12) bits as defined in clause 5.8.1.1 of TS 38.331;
viii) Communication range requirement-Four (4) bits as defined in TS 38.331;
Higher Layer Messages from TS 38.331:

| | |
|---|---|
| SL-PSCCH-Config-r16 ::= | SEQUENCE { |
| sl-TimeResourcePSCCH-r16 | ENUMERATED {n2, n3} |

OPTIONAL, -- Need M

| | |
|---|---|
| sl-FreqResourcePSCCH-r16 | ENUMERATED {n10,n12, n15, |
| | n20, n25} |

OPTIONAL, -- Need M

| | |
|---|---|
| sl-DMRS-ScrambleID-r16 | INTEGER (0..65535) |

OPTIONAL, -- Need M

| | |
|---|---|
| sl-NumReservedBits-r16 | INTEGER (2..4) |

OPTIONAL, -- Need M
...
}

The following Table 1 defines the SL-OSCCH field descriptions:

TABLE 1

SL-PSCCH field descriptions
sl-FreqResourcePSCCH
Indicates the number of PRBs for PSCCH in a resource pool
where it is not greater than the number PRBs of the subchannel.
sl-DMRS-ScrambleID
Indicates the initialization value for PSCCH DMRS scrambling.
sl-NumReservedBits
Indicates the number of reserved bits in first stage SCI.
sl-TimeResourcePSCCH
Indicates the number of symbols of PSCCH in a resource pool.

According to TS 38.212, SCI format 2-C is used for the decoding of PSSCH and providing inter-UE coordination information or requesting inter-UE coordination information. The following information is transmitted by means of the SCI format 2-C:
i) HARQ Process Number-Four (4) bits;
ii) New Data Indicator-One (1) bit;
iii) Redundancy Version-Two (2) bits as defined in Table 7.3.1.1.1-2;
iv) Source ID-Eight (8) bits as defined in clause 8.1 of TS 38.214;
v) Destination ID-16 bits as defined in clause 8.1 of TS 38.214;
vi) HARQ Feedback Enabled/Disabled Indicator-One (1) bit as defined in clause 16.3 of TS 38.213;
vii) CSI Request-One (1) bit as defined in clause 8.2.1 of TS 38.214 and in clause 8.1 of TS 38.214;
viii) Providing/Requesting Indicator-(1) bit, where value “0” indicates SCI format 2-C is used for providing inter-UE coordination information and value “1” indicates SCI format 2-C is used for requesting inter-UE coordination information;

If the “Providing/Requesting Indicator” field is set to zero (0), all the remaining fields are set as follows:
i) Resource combinations—

$$2 \cdot ( ⌈ {log}_{2} ( \frac{{N}_{sub Channel}^{SL} ( {N}_{subChannel}^{SL} + 1 ) ( 2 {N}_{subChannel}^{SL} + 1 )}{6} ) ⌉ + 9 + Y ) bits , \qquad a )$$

as defined in Clause 8.1.5A of TS 38.214, where
1) Y=┌log₂ N_{rsv_period}┐ and N_{rsv_period} is the number of entries in the higher layer parameter sl-ResourceReservePeriodList, if higher layer parameter sl-MultiReserveResource is configured;
2) Y=0 otherwise; and

$${N}_{subChannel}^{SL} \qquad 3 )$$

is the number of subchannels in a resource pool provided by the higher layer parameter sl-NumSubchannel;
ii) First Resource Location-Eight (8) bits as defined in Clause 8.1.5A of TS 38.214;
iii) Reference Slot Location-(10+┌log₂ (10·2^{μ})┐) bits as defined in Clause 8.1.5A of TS 38.214, where μ is defined in Table 4.2-1 of Clause 4.2 of TS 38.211;
iv) Resource Set Type—One (1) bit, where value “0” indicates preferred resource set and value “1” indicates non-preferred resource set;

$$Lowest SubChannel Indices - 2 \cdot ⌈ {log}_{2} {N}_{subChannel}^{SL} ⌉ bits \qquad v )$$

of TS 38.214;
If the “Providing/Requesting Indicator” field is set to “1”, all the remaining fields are set as follows:
i) Priority-Three (3) bits as specified in clause 5.4.3.3 of TS 23.287 and clause 5.22.1.3.1 of TS 38.321. Value “000” of Priority field corresponds to priority value “1”, value “001” of Priority field corresponds to priority value “2”, and so on;

$$Number of SubChannels - ⌈ {log}_{2} {N}_{subChannel}^{SL} ⌉ bits \qquad ii )$$

as defined in Clause 8.1.4A of TS 38.214;
iii) Resource Reservation Period—┌log₂ N_{rsv_period}┐ bits as defined in Clause 8.1.4A of TS 38.214, where N_{rsv_period} is the number of entries in the higher layer parameter sl-ResourceReservePeriodList, if higher layer parameter sl-MultiReserveResource is configured; zero (0) bits otherwise;
iv) Resource Selection Window Location-2·(10+┌log₂ (10·2^{μ})┐) bits as defined in Clause 8.1.4A of TS 38.214, where u is defined in Table 4.2-1 of Clause 4.2 of TS 38.211;
v) Resource Set Type-One (1) bit, where value “0” indicates a request for inter-UE coordination information providing preferred resource set and value “1” indicates a request for inter-UE coordination information providing non-preferred resource set, if higher layer parameter determineResourceSetTypeScheme1 is configured to “UE-B's request”; otherwise, zero (0) bits.
vi) Padding bits.

Sidelink Inter-UE Coordination (IUC)—In Rel-17, Sidelink Inter-UE Coordination (IUC) is specified to improve mode 2 reliability by overcoming certain issues, such as hidden-node, exposed-node, and half-duplex, that impact sidelink performance. Two IUC schemes were defined: Scheme 1 and Scheme 2, as follows:
A) Scheme 1—inter-UE coordination information signalling from UE-A to UE-B:
   1) Set of resources preferred for UE-B's transmission;
   2) Set of resources non-preferred for UE-B's transmission;
B) Scheme 2-inter-UE coordination information signalling from UE-A to UE-B:
   1) Presence of expected/potential resource conflict on the resources indicated by UE-B's SCI;
In IUC Scheme 1, two IUC triggering scenarios were considered and specified. The first triggering scenario include coordination triggered by an explicit request, where UE-B sends an explicit request to UE-A, and UE-A, upon request, generates and sends the coordination information (preferred resource set or non-preferred resource set) to UE-B. The second triggering scenario includes coordination triggered by a condition other than an explicit request, where a UE (e.g., UE-A) that satisfies certain condition(s) generates and sends coordination information to UE-B.

The conditions for the two IUC triggering scenarios were also specified. For inter-UE coordination (IUC) triggered by an explicit request, one of the two conditions is configured for the resource pool level: Alternative 1—up to UE-B's implementation and Alternative 2—the request can be triggered only when UE-B has data to be transmitted to UE-A. Similarly, for IUC triggered by a condition, two conditions were agreed with one of them enabled by resource pool level (pre-) configuration: Alternative 1—up to UE-A's implementation, and Alternative 2—the coordination can be triggered only when UE-A has data to be transmitted together with coordination information to UE-B.

The criteria for generating the coordination information, i.e., preferred resource set and non-preferred resource set are defined as follows.

A) Preferred resource set:
1) Condition 1-A-1: Resource(s) excluding the overlapped reserved resource(s) of another UE with RSRP larger than a threshold; and
2) Condition 1-A-2: Resource(s) excluding the slots when UE-A, as Rx of UE-B, does not expect to perform SL reception from UE-B.

B) Non-preferred resource set:
1) Condition 1-B-1: Reserved resource(s) of other UE identified by and RSRP measurement:
   a. Option 1: Reserved resource(s) of other UE(s) identified by UE-A whose RSRP measurement is larger than a (pre) configured RSRP threshold; and
   b. Option 2: Reserved resource(s) of other UE identified by UE-A whose RSRP measurement is smaller than a (pre) configured RSRP threshold when UE-A is a destination of a TB transmitted by the UE(s).
2) Condition 1-B-2: Resource(s) (e.g., slots) where UE-A, when it is intended receiver of UE-B, does not expect to perform SL reception from UE-B.

To send explicit request and coordination information, a MAC-CE is used as the container. If configured, the second stage SCI (SCI-2C) is also used for explicit request or coordination information. For coordination triggered by an explicit request, only unicast is supported for both transmissions of explicit request and coordination information. For coordination triggered by a condition, unicast is supported for transmission of both types of coordination information. Broadcast and groupcast are supported for non-preferred resource set only. The coordination information and explicit request can be transmitted multiplexed with data only if source/destination ID pair is the same.

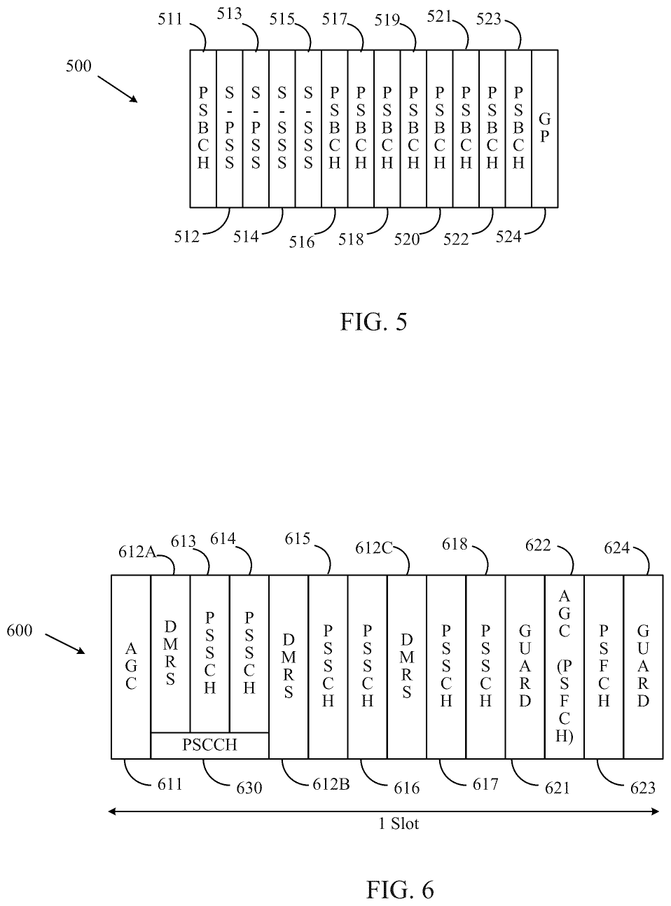

FIG. 5 illustrates the structure of a sidelink synchronization signal block (S-SSB) 500 according to an embodiment of the disclosure. An S-SSB is a synchronization slot in the sidelink that is specified for one user equipment (UE) to synchronize with another UE. As shown in FIG. 5, the first orthogonal frequency-division multiplexing (OFDM) symbol 511 is for the physical sidelink broadcast channel (PSBCH). But, like the regular sidelink slot, the first symbol is for settling the automatic gain control (AGC). Next, there are two symbols 512 and 513 for sidelink primary synchronization signal (S-PSS) and two symbols 514 and 515 for the sidelink secondary synchronization signal (S-SSS).

The next eight (8) symbols 516-523 of the remaining nine (9) symbols are for PSBCH transmission. The last symbol 524 is a guard period (GP), the same as in the regular sidelink slot. In the frequency domain, the S-SSB 500 occupies eleven (11) physical resource blocks (PRBs) with a total of 132 subcarriers. The PSBCH 511 occupies all eleven (11) PRBs when the size of synchronization signal is 127. Thus, the S-PSS 512, 513 and the S-SSS 514, 515 occupy 127 subcarriers. The periodicity of S-SSB 500 is 160 milliseconds. The frequency location of the S-SSB 500 is pre-configured. The number of S-SSB transmissions is set to “1” for frequency range 1 (FR1) and is configurable for frequency range 2 (FR2).

### Sidelink Resource Allocation May be Implemented as Follows.

### Mode 1 Resource Allocation—

In Rel-16, New Radio Vehicle to Everything (NR V2X) sidelink mode 1, the gNB performs scheduling of the sidelink. That is, the next generation node B (gNB) allocates the sidelink (SL) resources for SL communications and the resource allocation is sent to the UE through the NR-UE interface. Therefore, sidelink mode 1 is applicable to UEs under the coverage of a gNB. The resources allocated with mode 1 may be on the same carrier as cellular NR or on a dedicated sidelink carrier.

There are three types of mode 1 resource allocations: i) dynamic assignment, ii) type 1 configured grant (CG), and iii) type 2 configured grant. In dynamic assignment, the UE first sends a scheduling request (SR) for every transport block (TB) to the gNB via the physical uplink control channel (PUCCH). Then, the gNB sends an SL resource allocation to the UE via downlink control information (DCI) format 3_0 over the physical downlink control channel (PDCCH). In CG based resource allocation, the UE first sends a message to the gNB with the expected SL traffic (e.g., periodicity, the TB maximum size, and QoS information). The gNB provides resource allocation, (i.e., a CG to the UE the gNB provides by radio resource control (RRC) signaling). In type 1 CG, the UE can use the resource allocation immediately. In type 2 CG, the UE uses the allocated resources only after activated by gNB via a DCI.

### Mode 2 Resource Allocation

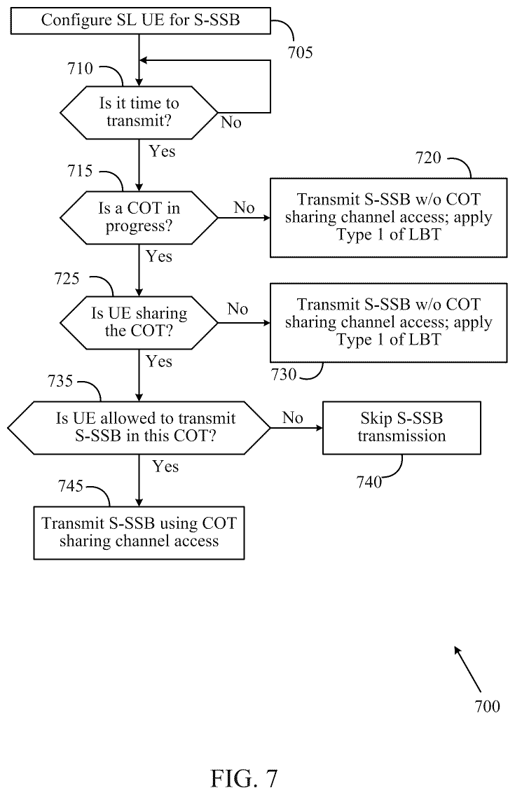

In Rel-16 sidelink, mode 2, the UEs transmit and receive information without the need of the network management. The UEs themselves allocate the resources from a resource pool for sidelink transmissions. Resource allocation relies on a sensing and reservation process as shown in FIG. 7. During the sensing procedure, a monitoring UE detects SCI transmitted in each slot in the sensing window and measures the reference signal received power (RSRP) of the resource indicated in the SCI. A monitoring UE may also receive transmissions of data (also be a receiving UE). For periodic traffic, the resource reservations for sidelink transmissions, if a UE occupies a resource on slot sₖ, it will also occupy the resource on slot sₖ+q*RRIₖ, where q is an integer, RRIₖ is resource reservation interval for UE m that the sensing UE detected. Detecting the SCI includes the steps of receiving and decoding the PSCCH and processing the SCI within the PSCCH.

For aperiodic or dynamic transmissions, the transmitting UE reserves multiple resources and indicates the next resource in the SCI. Therefore, based on the sensing results, a monitoring UE can determine which resources may be occupied in the future and can avoid them for its own transmission if the measured RSRP on the occupied resource during the sensing period is above the RSRP threshold in the resource exclusion procedure as described in TS38.214.

### NR-U Unlicensed Channel Access—

The licensed exempt spectrum, also known as “unlicensed spectrum” or “shared spectrum”, attracted interest from cellular operators in recent years. The LTE-LAA (licensed assisted access) was specified in 3GPP LTE releases 13 and 14. More recently in new radio unlicensed (NR-U), the operation in unlicensed spectrum (shared spectrum) was specified in release 16 of TS 38.213. The 3GPP and IEEE technologies operating in unlicensed spectrum use Listen-Before-Talk (LBT) channel access. In certain regions, such as the European Union and Japan, the LBT rule is enforced by the spectrum regulators to reduce the interference risk and to offer a fair coexistence mechanism. The LBT mechanism requires the transmitter to check before sending a transmission to see if there are other occupants of the channel and postpone the transmission if the channel is occupied.

In particular, the Listen-Before-Talk (LBT) rule in the EU specified in ETSI EN 301.893 for 5 GHz band uses a clear channel assessment (CCA) to determine if the channel is available for transmission. A CCA checks if the energy received is above a threshold. If the energy detected exceeds the CCA threshold, the channel is considered in use (busy). Otherwise, the channel is considered idle.

“Channel occupancy” is key information to realize efficient operation of a wireless system. Channel occupancy can be defined as the time occupancy ratio of a wireless network. In other words, a “channel occupancy” refers to transmission(s) on channel(s) by eNB, gNB, and UE(s) after performing the corresponding channel access procedures. A “channel occupancy time” (COT) refers to the total time for which the eNB, gNB, UE and any eNB/gNB/UE(s) sharing the channel occupancy perform transmission(s) on a channel after an eNB/gNB/UE performs the corresponding channel access procedures. For determining a channel occupancy time, if a transmission gap is less than or equal to 25 μsec., the gap duration is counted in the channel occupancy time. A channel occupancy time can be shared for transmission between an eNB/gNB and the corresponding UE(s). If a channel is idle, the transmitter can transmit for a duration of channel occupancy time (COT) at a bandwidth of at least, for example, 80% of the total channel bandwidth.

The maximum COT duration for a transmission burst is also specified in ETSI EN 301.893. The maximum COT (MCOT) duration adopted in 3GPP NR-U Rel 16 of TS 37.213 is a function of channel access priority class (CAPC). As specified in TS 37.213, for determining a channel occupancy time (COT), if a transmission gap is less than or equal to 25 μsec., the gap duration is counted in the channel occupancy time. A transmission burst is defined as a set of transmissions with gaps no more than 16 μsec. If the gaps are larger than 16 μsec, the transmissions are considered separate.

In TS 37.213, the 3^{rd} Generation Partnership Project (3GPP) defines several types of channel access for the downlink (DL) and the uplink (UL), including:
I. Type 1 UL channel access procedure
II. Type 2 UL channel access procedure
III. Type 2A UL channel access procedure
IV Type 2B UL channel access procedure
V. Type 2C UL channel access procedure

These channel access procedures are described below.

I. Type 1 UL Channel Access Procedure describes channel access procedures by a UE where the time duration spanned by the sensing slots that are sensed to be idle before a UL transmission(s) is random. The clause is applicable to the following transmissions: i) PUSCH/SRS transmission(s) scheduled or configured by an access node (i.e., eNB/gNB); ii) PUCCH transmission(s) scheduled or configured by gNB; or iii) transmission(s) related to random access procedure.

A UE may transmit the transmission using Type 1 channel access procedure after first sensing the channel to be idle during the slot durations of a defer duration, Ta, and after the counter N is zero in step 4 below. The counter N is adjusted by sensing the channel for additional slot duration(s) according to the steps described below.
Step 1—Set N=Nᵢₙᵢₜ, where Nᵢₙᵢₜ is a random number uniformly distributed between 0 and CWₚ, and go to step 4;
Step 2—If N>0 and the UE chooses to decrement the counter, set N=N−1;
Step 3—Sense the channel for an additional slot duration and, if the additional slot duration is idle, go to step 4. Otherwise, go to step 5;
Step 4—If N=0, stop. Otherwise, go to step 2;
Step 5—sense the channel until either a busy slot is detected within an additional defer duration T_{d} or all the slots of the additional defer duration T_{d} are detected to be idle; and
Step 6—If the channel is sensed to be idle during all the slot durations of the additional defer duration Ta, go to step 4. Otherwise, go to step 5.

If a UE has not transmitted an UL transmission on a channel on which UL transmission(s) are performed after step 4 in the procedure above, the UE may transmit a transmission on the channel, if the channel is sensed to be idle at least in a sensing slot duration Tₛₗ when the UE is ready to transmit the transmission and if the channel has been sensed to be idle during all the slot durations of a defer duration T_{d} immediately before the transmission. If the channel has not been sensed to be idle in a sensing slot duration Tₛₗ when the UE first senses the channel after it is ready to transmit, or if the channel has not been sensed to be idle during any of the sensing slot durations of a defer duration T_{d} immediately before the intended transmission, the UE proceeds to step 1 after sensing the channel to be idle during the slot durations of a defer duration T_{d}.

The defer duration T_{d} consists of duration T_{f}=16 usec immediately followed by mₚ consecutive slot durations where each slot duration is Tₛₗ=9 usec, and T_{f} includes an idle slot duration Tₛₜ at start of T_{f}. The contention window is given by CW_{min,p}≤CWₚ≤CW_{max,p}. The contention window adjustment is described in clause 4.2.2. The values CW_{min,p} and CW_{max,p} are chosen before step 1 of the procedure above. The values mₚ, CW_{min,p}, and CW_{max,p} are based on a channel access priority class p as shown in Table 4.2.1-1 that is signaled to the UE.

II. Type 2 UL Channel Access Procedure describes channel access procedures by UE where the time duration spanned by the sensing slots that are sensed to be idle before a UL transmission(s) is deterministic. If a UE is indicated by an eNB to perform Type 2 UL channel access procedures, the UE follows the procedures described in the clause (“Type 2A UL channel access procedure”) below.

III. Type 2A UL channel access procedure—If a UE is indicated to perform Type 2A UL channel access procedures, the UE uses Type 2A UL channel access procedure for a UL transmission. The UE may transmit the transmission immediately after sensing the channel to be idle for at least a sensing interval T_{short_ul}=25 usec. The interval T_{short_ul} consists of a duration T_{f}=16 usec. immediately followed by one sensing slot and T_{f} includes a sensing slot at start of T_{f}. The channel is idle for T_{short_ul} if both sensing slots of T_{short_ul} are sensed to be idle.

IV. Type 2B UL channel access procedure-If a UE is indicated to perform Type 2B UL channel access procedures, the UE uses Type 2B UL channel access procedure for a UL transmission. The UE may transmit the transmission immediately after sensing the channel to be idle within a duration of T_{f}=16 usec. The duration T_{f} includes a sensing slot that occurs within the last 9 usec. of T_{f}. The channel is idle within the duration T_{f} if the channel is sensed to be idle for total of at least 5 us with at least 4 us of sensing occurring in the sensing slot.

V. Type 2C UL Channel Access Procedure-If a UE is indicated to perform Type 2C UL channel access procedure for a UL transmission, the UE does not sense the channel before the transmission. The duration of the corresponding UL transmission is at most 584 usec.

A UE transmits, using Type 1, the channel access procedure after first sensing the channel to be idle during the sensing slot duration of a defer duration Td, and after the counter N is zero. The counter N is initialized with a random value larger than minimum contention window (CWₘᵢₙ) and smaller than maximum contention window value (CWₘₐₓ) and decremented when sensing the channel idle for additional sensing slot duration(s) Ts. The values of CWₘᵢₙ and CWₘₐₓ are based on the channel access priority class (CAPC) that is signaled to UE. After the successful Listen-Before-Talk (LBT) procedure, a device may continuously transmit without another LBT procedure for the maximum channel occupancy time (COT), which is also based on CAPC as defined in TS 37.213.

The total channel occupancy time (COT) of autonomous uplink transmission(s) obtained by the channel access procedure in this clause, including the following DL transmission if the UE sets “COT sharing indication” in autonomous uplink UCI (AUL-UCI) to “1” in a subframe within the autonomous uplink transmission(s) as described in clause 4.1.3, may not exceed T_{ulm cot,p}, where T_{ulm cot,p} is given in Table 4.2.1-1 Channel Access Priority Class (CAPC) for UL in TS 37.213.

TABLE 4.2.1-1
Channel Access Priority Class (CAPC) for UL (TS 37.213)

| Channel Access | | | | | |
|---|---|---|---|---|---|
| Priority Class (p) | mₚ | CW_{min, p} | CW_{max, p} | T_{ulm cot, p} | allowed CWₚ sizes |
| 1 | 2 | 3 | 7 | 2 ms | {3, 7} |
| 2 | 2 | 7 | 15 | 4 ms | {7, 15} |
| 3 | 3 | 15 | 1023 | 6ms or 10 ms | {15, 31, 63, 127, 255, 511, 1023} |
| 4 | 7 | 15 | 1023 | 6ms or 10 ms | {15, 31, 63, 127, 255, 511, 1023} |

When using a higher CAPC, a device on average accesses the channel faster (due to the limit of CWₘₐₓ) and for a shorter duration (due to the maximum COT duration, T_{ulm cot,p}). A lower CAPC value means higher priority and a higher CAPC value means lower priority.

The channel access priority classes (CAPC) of radio bearers and media access control (MAC) control elements (CEs) are either fixed or configurable according to TS 38.300. These elements are: i) fixed to the lowest priority for the padding buffer status reporting (BSR) and recommended bit rate MAC CEs; ii) fixed to the highest priority for signalling radio bearer (SRB)0, SRB1, SRB3, and other MAC CEs; and iii) configured by the gNB for SRB2 and data radio bearer (DRB). TS 38.300 also defines additional rules for using the CAPC priority for UL channel access.

When performing Type 1 Listen Before Talk (LBT) for the transmission of an uplink TB (see TS 37.213, clause 4.2.1.1) and when the CAPC is not indicated in the DCI, the UE may select the CAPC as follows: i) if only MAC CE(s) is included in the transport block (TB), the highest priority CAPC of those MAC CE(s) is used; ii) if common control channel (CCCH) service data unit(s) (SDU(s)) are included in the TB, the highest priority CAPC is used; iii) if dedicated control channel (DCCH) SDU(s) are included in the TB, the highest priority CAPC of the DCCH(s) is used; or iv) the lowest priority CAPC of the logical channel(s) with MAC SDU multiplexed in the TB is used otherwise.

When a UE uses Type 1 channel access procedures for physical uplink shared channel (PUSCH) transmissions on a configured resource, the UE determines the corresponding UL channel access priority, p, in Table 4.2.1-1 of TS 38.300. When a UE uses Type 1 channel access procedures for PUSCH transmissions with user plane data indicated by a UL grant or related to random access procedure where the corresponding UL channel access priority, p, is not indicated, the UE determines p in Table 4.2.1-1 following the same procedures as for PUSCH transmission on configured resources using Type 1 channel access procedures.

The CAPC values are provided to UE via ChannelAccess-CPext field in downlink control information (DCI) Format 0_0, DCI Format 0_1 and Format 0_2, Format 1_0, Format 1_1 and Format 1_2 as defined in TS 38.212. DCI format 0_1 is used for the scheduling of one or multiple PUSCH in one cell or indicating CG downlink feedback information (CG-DFI) to a UE. DCI format 0_2 and DCI format 0_0 are used for the scheduling of PUSCH in one cell. DCI format 1_0 is used for the scheduling of PDSCH in one DL cell. DCI format 1_1 is used for the scheduling of one or multiple PDSCH in one cell. DCI format 1_2 is used for the scheduling of PDSCH in one cell.

TS 38.212 specifies the allowed entries for channel access values for dynamic and semi-static modes. In current systems, there is no sidelink specification in shared spectrum. (SL-U). It is expected that the SL-U may follow the NR-U channel access specified in TS 37.213. Moreover, it is expected that that SL-U reuses as much as possible the SL resource allocation methods. CAPC is not defined for all possible values of SL priorities used for resource reservation or the other way around. Thus, one possible issue that may occur when the CAPC for unlicensed channel access and SL resource priority are used independently and based on the existing specification is that some combinations of CAPC and SL priority may be inconsistent. For instance, it may happen that a CAPC class of high priority (for instance “1”) is used to access a reservation made with a SL resource reservation low priority (for instance “8”) or the other way around. This may lead to unfair channel access and resource allocation, which may be detrimental to QOS for different flows.

For Mode 1 resource allocation, one issue is that the DCI format 3_0 does not provide the necessary parameters for SL unlicensed access, for instance, CAPC. DCI format 3_0 is defined in TS 38.212 and is used for scheduling of NR PSCCH and NR PSSCH in one cell. DCI format 3_1 is defined in the same document and is used for scheduling of LTE PSCCH and LTE PSSCH in one cell. For Mode 2 resource allocation, one issue is that CAPC and SL Priority Level do not cover the same type of traffic. There is a need to accommodate different types of priorities (for channel access and resource selection).

The CAPC is used for Listen-Before-Talk (LBT) sensing COT maximum duration. The timing for LBT (based on CAPC values) is very short-on the order of tens to no more than few hundreds of microseconds for 5 GHz bands, which may be equivalent to one or a few OFDM symbols duration. For instance, when CAPC=1, the LBT duration (when successful) corresponds to a sensing slot duration (9 μsec.) plus the backoff period duration (between 3×9 and 7×9 μsec.), that is less than 73 μsec. The subcarrier spacing values of {15, 30, 60, 120} kHz correspond to the OFDM symbol duration of {66.7, 33.3, 16.7, 8.33} μsec., respectively.

The purpose of SL resource reservation is to reserve some resources for future transmissions. These reservations are made only in the SL resources (which is a subset of UL resources when sidelink and uplink are on the same carrier), and the reservations are decoded and respected only by SL UE devices, which can decode sidelink control information (SCI). The reservation methodology is specified by 3GPP and followed only by the 3GPP devices that implement this feature. However, the channel access (based on CAPC) is mandated for any type of device (thus non-3GPP) that operates in EU 5 GHz unlicensed bands and is specified by ETSI.

The durations of SL resource reservation windows are much longer than the channel access LBT. The SL sensing window is up to 100 msec., while the resource selection window duration is T2-T1 (see FIG. 2) where T1 can be as low as zero and T2 min includes {1, 5, 10, 20}*2^{μ} slots, where μ values {0, 1,2,3} correspond to SCS values of {15, 30, 60, 120} kHz. This results in T2 min values equivalent to {1, 5, 10, 20} msec.

For each transmission in the unlicensed sidelink (SL-U), the UE uses CAPC to gain channel access, and for each resource selection corresponding to that transmission, the SL-U UE uses the corresponding SL Priority Level. For instance, the DCI format 3_0 can be extended to cover the SL-U allocations for Mode 1 with a bit field dedicated to CAPC when the resource pool index indicates a shared spectrum transmission. In another embodiment, the DCI may have a bit field that indicates that the resource pool index is used for shared spectrum access.

Channel occupancy time (COT) is specific to shared spectrum (unlicensed) channel access. A UE may or may not be required to perform an LBT prior to transmissions that take place either at a reserved resource or without reservation. The following are examples where transmissions may not require an LBT procedure (i.e., channel sensing): i) if there is a short control transmission (with a short duration as specified by 3GPP NR-U and ETSI BRAN specs) (Type 2C); and ii) if there is a transmission in a shared COT that immediately follows another transmission in the same COT. The following are examples where transmissions may require LBT procedure (i.e., channel sensing): i) when transmission requires initiating a COT (Type 1); and ii) when transmission in in a shared COT with a gap with respect to previous transmission (for instance Type 1, Type 2A, Type 2B).

In an embodiment, the SL UE that initiated COT (e.g., initiating UE) is the SL UE that successfully executes a Type 1 Listen-Before-Talk (LBT) followed by a transmission, which is not done in a shared COT. The UE that initiates a COT may or may not share its COT with other UEs. Those UEs that share a COT with the initiating UE may be called “responder UEs”.

COT sharing is also supported in Mode 2. In this mode, the important information for COT sharing is provided in SCI. The present disclosure provides solutions for COT sharing for SL for different resource reservations and LBT outcomes.

FIG. 6 illustrates a typical transmission time slot 600 including a physical sidelink feedback channel (PSFCH) 623 occasion according to an embodiment of the disclosure. The transmission time slot 600 includes PSFCH 623 and guard symbols 621 and 624 for a receive-to-transmit (Rx-Tx) switch. The time slot 600 also includes automatic gain control region 611, demodulation reference signal (DMRS) regions 612A, 612B, and 612C, PSSCH regions 613-618, and AGC-PSFCH region 622.

In unlicensed channel access, if a transmission is part of COT sharing, the gaps between consecutive transmissions determine the channel access sensing prior to transmission: i) for gaps less than 16 μsec., there is no need for channel sensing; ii) for gaps equal to 16 μsec., the channel may be sensed for 16 μsec., iii) for gaps equal to 25 μsec., the channel may be sensed for 25 μsec.; and iv) for gaps larger than 25 us, a full listen-before-talk (LBT) operation with random backoff may be performed.

In the unlicensed sidelink (SL-U), it was decided that there are two possible starting symbols in a slot, where the second starting symbol is used if the Listen-Before-Talk (LBT) operation before the first starting symbol fails. If the LBT operation fails before the 1st starting symbol, a problem may occur regarding how to handle the PSFCH. To address this problem, more PSFCH occasions (or occurrences) may be implemented to mitigate LBT failures before a PSFCH occurrence. However, it is then beneficial to indicate when and how the additional PSFCH occasions occur. For higher SCS (60 kHz), there is not enough time for LBT. As a result, the PSSCH transmissions prior to PSFCH may make an LBT operation fail, requiring additionally techniques to handle PSFCH at higher subcarrier spacing (SCS) values.

In TS 37.213, multi-channel channel access is defined for multi-channel transmissions. However, multi-channel channel occupancy time (COT) is not defined. Thus, it is necessary to define multi-channel COT and its sharing. RAN1 supports unlicensed sidelink (SL-U) multi-consecutive slots transmission (MCSt). The present disclosure provides a solution for MCSt for slots having two possible starting symbols, particularly for MCSt when the first starting symbol fails LBT.

In NR-U systems, persistent LBT failure is reported to the network. However, the LBT is executed only before a transmission and does not offer a complete picture of unlicensed channel occupancy. It is advantageous for unlicensed sidelink systems to have a more complete picture of the unlicensed band usage for a better schedule of access. It is advantageous to provide SL-SSB transmission in and out of channel occupancy time (COT) sharing.

S-SSB-A sidelink synchronization signal block (S-SSB) transmission may use the Type 2A access procedure outside of COT sharing, under the duty cycle constraints. If the duty cycle constraints cannot be satisfied, Type 1 channel access can be used. When Type 1 channel access is used, the channel access priority class (CAPC) value is set to 1. Type 1 channel access may be used to initiate a COT. However, in order to initiate a COT, other information should be provided by the COT initiator, such as the remaining COT duration, the identity of UEs that can share that COT, the energy threshold (ED) that should be used in that COT for channel access purposes. In one embodiment, a user equipment (UE) transmitting a S-SSB is allowed to initiate a COT provided that the UE transmits together with the S-SSB the necessary information for COT initiation and COT sharing or an indication that S-SSB initiates a COT. However, given the specific format of S-SSB, such information may be difficult to be signaled. In an embodiment, the disclosed UE may use an unused bit of the PSBCH.

In another embodiment, the sidelink synchronization signal block (S-SSB) always initiates a COT and the necessary information for sharing the COT (e.g., the remaining time, the energy detection threshold, IDs of the UEs that can share the COT) follows in the next slot via a PSCCH/PSSCH transmission (SCI-2). However, if a UE only sends the S-SSB, it may not be beneficial to keep channel control more than necessary. For this reason, in some embodiments, the S-SSB transmission does not initiate a COT. As a result, in some embodiments, if the transmission of S-SSB does not carry the necessary information for COT sharing or is not followed in the consecutive slot by the PSCCH/PSSCH that carries such information, the COT is not initiated.

In principle, a COT may be initiated without sharing, provided that the COT contains only transmissions from the UE that initiates that COT. This does not contravene the above condition. In other words, a UE may initiate a COT via a S-SSB, without sharing, provided the next slot provides the information regarding the remaining COT duration. The present disclosure provides a technique for a UE attempting to transmit the S-SSB with respect to an ongoing COT.

A UE that is able to share an ongoing COT is called a “responding” UE and may satisfy some conditions in order to be able to share the COT. A UE is a responding UE for COT sharing if either of two conditions apply: i) when the UE is a receiving UE (of PSCCH/PSSCH); or ii) when the UE is identified (via its ID) in the COT sharing information. RAN1 #111 allows a responding UE to transmit S-SSB in a shared COT. More precisely, for UE-to-UE COT sharing, when performing S-SSB transmission(s), a responding UE can utilize a COT shared by a COT initiating UE (using type 1 channel access) when the responding UE is intended to transmit S-SSB within RB set(s) corresponding to the shared COT.

To enable S-SSB transmissions in a shared COT, a COT initiator should either keep track of the possible S-SSB transmitters in its neighborhood and either know their schedules or use them as destinations. This may increase the UE complexity. The UE IDs derived from S-SSB transmissions are not in one-to-one mapping to the real UE ID. More precisely, the ID used in the sequence of PSS/SSS is related to the synchronization source rather than the ID of the UE. Therefore, other means are necessary to derive the real UE IDs that transmit S-SSB. Limiting transmission of S-SSB only to responding UEs may affect the synchronization and the discovery procedures as other potential S-SSB transmitters are not allowed to transmit during a shared COT.

One technique for S-SSB transmission in a shared COT allows S-SSB transmissions in a shared COT when the S-SSB transmitter can decode the COT sharing information. For this technique, the channel access for S-SSB transmission should respect the COT sharing channel access rules. In such a case, the S-SSB transmission may have CAPC set to 1. This indicates the S-SSB transmission can be done in any COT regardless of the CAPC value used by the COT initiator.

Alternative techniques may enable the COT initiator to explicitly allow or forbid S-SSB transmissions in its COT. For instance, the COT initiator may have a bit indication in the COT sharing information indicating that, during that COT, S-SSB transmissions other than from the COT initiator may or may not be allowed. Another technique is that enables a COT initiator to add to the identities of UEs that allow sharing that COT a bit indicating whether they are also allowed to transmit a S-SSB. Another technique is a (pre-) configuration per resource pool indicating whether an S-SSB transmission is allowed in the shared COT or not. This configuration may be provided to the UE at initial access of gNB via SIB or RRC signaling for instance.

FIG. 7 is a flowchart 700 illustrating sidelink synchronization signal block (S-SSB) transmission according to an embodiment of the disclosure. In step 705, a sidelink-enabled user equipment is configured for sidelink synchronization signal block (S-SSB) transmission. In step 710, the UE determines if it is time to transmit. If NO in step 710, the UE repeats the step 710. If YES in step 710, then in step 715, the UE determines if a channel occupancy time (COT) is in progress. If NO in step 715, then in step 720, the UE transmits the S-SSB without COT sharing channel access and performs Listen-Before-Talk (LBT) operation using a Type 1 uplink channel access procedure.

If YES in step 715, then in step 725, the UE determines if it is sharing the COT with another device, such as another UE, for example. If NO in step 725, then in step 730, the UE transmits the S-SSB without COT sharing channel access and performs Listen-Before-Talk (LBT) operation using a Type 1 uplink channel access procedure. If YES in step 725, then in step 735, the UE determines if the UE is permitted to transmit an S-SSB transmission in the current COT. If NO in step 735, then in step 740, the UE skips the S-SSB transmission. If YES in step 735, then in step 745, the UE transmits the S-SSB using COT sharing channel access.

PSFCH—PSFCH transmission uses CAPC set to 1 when Type 1 channel access is used. Only a single CPE (Cyclic prefix extension) starting position is supported for PSFCH. RAN1 does not disclose a CPE starting position is provided (i.e., configured, pre-defined, or indicated, etc.). The CPE location may be, for instance, such that the transmission gap prior to the PSFCH AGC symbol is 16 μsec. or less to avoid the need for a clear channel assessment or 25 μsec. to have a short deterministic clear channel assessment. Using a configuration or an indication of CPE location allows a more flexible approach than having a pre-defined CPE starting position. This flexibility may not be necessary given that PSFCH is a high priority control message. Therefore, the CPE may be pre-defined such that at most a 16 usec. gap between prior transmission and the AGC PSFCH symbol is guaranteed.

Whether Type 2A channel access can be supported for the PSFCH transmission and whether the constraints for duty cycle should apply are not supported. In RAN1 #111, when performing PSFCH transmission(s), a responding UE can utilize a COT shared by a COT initiating UE at least when at least one of the responding UEs PSFCH transmissions in a symbol/slot within RB set(s) corresponding to the shared COT is intended for the COT initiating UE. In one embodiment, a responding UE transmits PSFCH to an SL UE (which may not be a responding UE) other than the COT initiator if the responding UE transmits at the same time PSFCH to the COT initiator.

When there are combined transmissions of both S-SSB and PSFCH using Type 2A channel access procedure, it may impact S-SSB transmission or may lead to the need of additional rules for the transmission decision when the exempt rules are not met. If the duty cycle of S-SSB and PSFCH together is very low, there is no issue and both S-SSB and PSFCH can use Type 2A for channel access. On the other hand, if additional PSFCH and/or S-SSB occasions are added to compensate for possible LBT failure, the duty cycle limit may be exceeded.

In one embodiment of Type 2A for PSFCH, when the exempt rules are not met, Type 2A channel access should not be applied to PSFCH to allow the gNB to configure whether Type 2A channel access may be used for PSFCH. Having some UEs that use Type 2A channel access and some UEs that do not use Type 2A channel access for PSFCH may create a fairness issue. If both transmissions of S-SSB and PSFCH are using Type 2A channel access, their duty cycles are lumped together. This approach requires that if the duty cycle limit is reached, Type 2A channel access cannot be used anymore, which could impact S-SSB transmission if S-SSB transmission uses Type 1 channel access. To avoid this situation, if the duty cycle limit is close to being reached, PSFCH may be transmitted using Type 1 channel access, while S-SSB continues to be transmitted with Type 2A, 2B, or 2C channel access.

It is noted that a UE needs to predict when the duty cycle limit will be reached and stop using Type 2A channel access for PSFCH prior to this limit being reached. To avoid impacting the S-SSB transmission, this approach leads to a conservative decision to stop Type 2A channel access usage for PSFCH. In any case, situations when PSFCH cannot use Type 2A channel access may occur. Therefore, a practical technique for PSFCH transmission is to use Type 1 for channel access with CAPC value of 1, rather than transmitting PSFCH using a Type 2A channel access. In one embodiment, the S-SSB is transmitted using Type 2A channel access, while a PSFCH is transmitted using Type 1 or other than Type 2A channel access.

Sidelink supports subcarrier spacings of 15, 30, 60 and 120 kHz. Type 2A channel access consists of sensing the channel idle for at least 25 μsec. For higher SCS (60 and 120 kHz), 25 usec. is longer than a single OFDM symbol duration, which is the duration of the guard symbol. Therefore, even using Type 2A channel access, the transmission of PSFCH may be blocked by the transmission of PSCCH/PSSCH.

In Type 1 channel access, the channel may be sensed to be idle during all the sensing slot durations of a defer duration T_{d} immediately before transmission. For CAPC=1, the defer duration is 25 μsec. Therefore, the blockage may occur for high SCS as in Type 2A channel access. Transmission of PSFCH is relatively short as it occupies only two symbols, which means that it can take between 18 μsec. at SCS 120 kHz to 143 μsec. at SCS 15 kHz. For short control signal transmission, Type 2C channel access is allowed if the transmission takes less than 584 μsec. In order to avoid the blockage of PSFCH due to PSSCH transmission, Type 2C channel access may be used. In this way, the blockage issue is solved for the PSSCH transmissions, which is expected during shared COT, while for other types of transmissions present in the channel, such as WiFi, which is expected for transmissions without COT sharing, the blockage is avoided via Type 1 channel access.

Therefore, in an embodiment, the S-SSB is transmitted using Type 2A channel access and PSFCH is transmitted using Type 2C channel access (no channel sensing) during COT sharing and using Type 1 channel access without COT sharing. This approach may be (pre-) configured per resource pool. For mode 1 (Scheme 1) it can be provided via SIB or for both modes (mode 1 and mode 2) via RRC configuration. In an alternate embodiment, the type of channel access for S-SSB transmissions and for PSFCH transmission is provided by the COT initiator as a part of COT sharing information.

For sidelink unlicensed transmissions, two possible starting point symbols are supported. If the LBT fails prior to the first starting symbol, a second LBT can be executed before the second starting symbol and, if successful, the sidelink transmission may start. This transmission may overlap with the PSFCH transmission occasion, which is not desired.

In one embodiment in a PSFCH slot, if the LBT period before the first starting symbol fails, the UE cancels its transmission of PSCCH and PSSCH in order to avoid overlap with PSFCH. In a different embodiment, if the second starting symbol is rather close to the first starting symbol, such that there are enough resources to transmit a PSCCH and a short (optional) PSSCH without overlapping the PSFCH, the transmission of PSCCH and PSSCH is maintained. In a different embodiment, if the transmission in the first starting symbol fails due to LBT failure, the transmission in the second starting symbol proceeds and there is signaling (for instance in SCI-2) to cancel PSFCH transmission. The signaling occurs prior to the PSFCH occasion.

In order to deal with potential failures at the PSFCH transmission, for instance LBT failure, additional PSFCH occasions may be added and dynamically signaled. Thus, if the transmission of PSFCH fails on some default occasions, additional occasions may be used. In a COT, there is more protection of the transmissions due to the Type 1 channel access that preceded COT start and due to short gaps between transmissions. Thus, the additional PSFCH occasions might not be necessary. Configuration or pre-configuration per resource pools may indicate the additional PSFCH occasions and may indicate that these are disabled during a COT sharing. This may be addressed by (pre-) configuring two sets of periodicities in and out of COT.

Alternatively, the COT initiator may decide and signal to UE sharing the COT the available PSFCH occasion (i.e., disable additional PSFCH occasions during the COT). For instance, it may indicate dynamically at the transmission (for instance SCI format-2) what are the (additional) PSFCH occasions allowed for that transmission HARQ. When additional PSFCH occasions are unused, a dynamic signaling to cancel unused additional PSFCH by the COT initiator for the rest of the COT, or per transmission basis may be used. The present disclosure provides a new SCI format: SCI-1 or SCI-2-bit fields to cancel the additional PSFCH occasions.

As in other scenarios in the present disclosure, the configuration may be provided by the usual means, such as SIB, RRC, MAC CE, etc. These configurations may or may not be associated with a validity timer and another default (pre-) configuration if the timer expires.

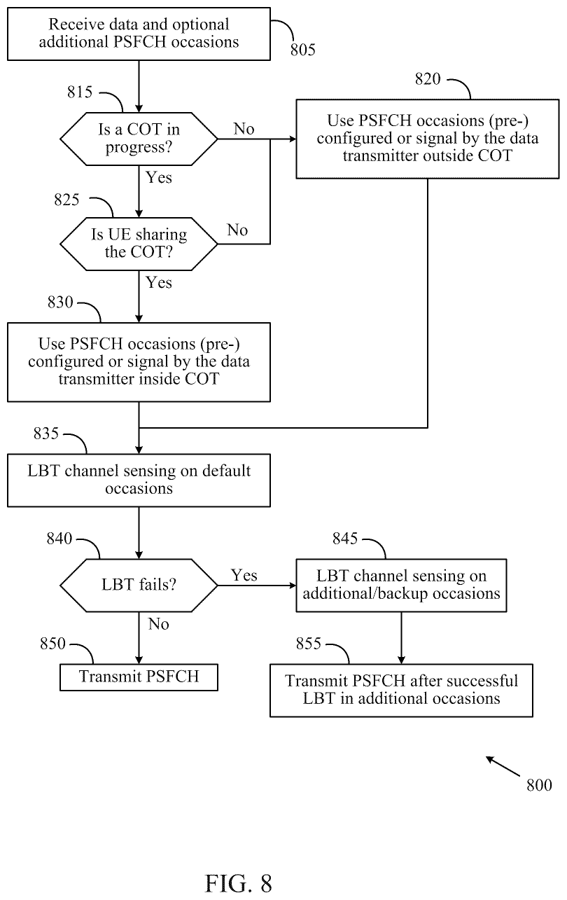

FIG. 8 is a flowchart 800 illustrating an example of PSFCH transmission flow according to an embodiment of the present disclosure. In step 805, the UE may receive data and optional additional PSFCH occasions (or instances). In step 815, the UE determines if a COT is in progress. If NO in step 815, then in step 820, the UE may use PSFCH occasions (pre-) configured or signaled by the data transmitter outside the COT and then proceeds to step 835. If YES in step 815, then in step 825, the UE determines if the UE is sharing the COT with other UEs. If NO in step 825, then in step 820, the UE may use PSFCH occasions (pre-) configured or signaled by the data transmitter outside the COT. If YES in step 825, then in step 830, the UE may use PSFCH occasions (pre-) configured or signal by the data transmitter inside the COT and then proceed to step 835.

In step 835, the UE performs LBT channel sensing on default occasions. In step 840, the UE determines if there has been an LBT fail. If YES in step 840, then in step 845, the UE performs LBT channel sensing on additional occasions or backup occasions. Next, in step 855, the UE transmits the PSFCH after a successful LBT in additional occasions. If NO in step 840, the UE transmits the PSFCH.

Multi-channel COT definition and access-Regarding multi-channel transmissions, per RAN1 #110b, for dynamic channel access mode with multi-channel case in SL-U, the NR-U UL channel access procedure is considered as baseline for transmission on multiple channels. NR-U UL multi-channel access procedure requires as a necessary condition for multi-channel transmission that UE can access all the channels of the carrier bandwidth on which the UE is scheduled or configured with UL resources. TS 37.213 does not define a multi-channel COT, but rather defines the conditions for multi-channel access, but there is no explicit definition of multi-channel COT and multi-channel COT sharing. More precisely, the multi-channel transmission is a single transmission.

Using the NR-U UL multi-channel access as the baseline implies that a SL UE cannot transmit in any channel (RB set) (cᵢ∈C) on which the UE is scheduled or configured with SL resources if it fails to access any channel on which the UE is scheduled or configured with SL resources. For multi-channel access, the transmission should be preceded by a successful LBT Type 1 procedure on a channel randomly selected and a successful LBT Type 2 on each of the other BPW channels. In other words, to transmit on channel c; (where c; E C is uniformly randomly selected), the SL UE uses Type 1 channel access and to transmit on channel cᵢ≠cⱼ, cᵢ∈C, the SL UE may sense the channel cᵢ for at least a sensing interval T_{mc}=25 μsec. For the multi-channel transmission to proceed the sensing in each channel (RB set) should indicate that the channel is available.

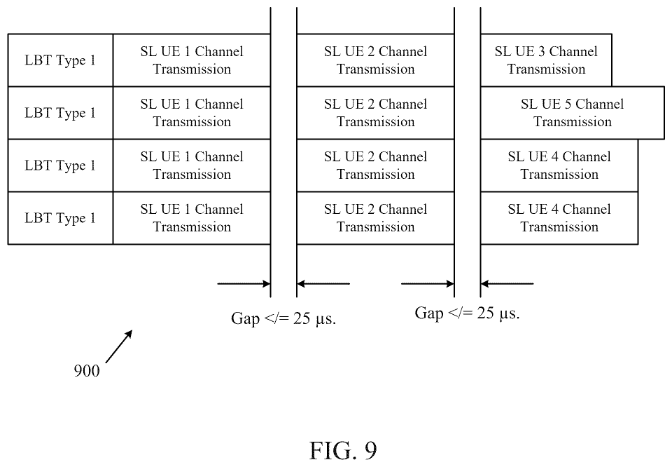

Sidelink multi-channel transmission may decide/define how long the multi-channel transmission can take place. In an embodiment, the maximum duration of multi-channel transmission on any channel cᵢ≠cⱼ, cᵢ∈C, may not exceed T_{m cot,p}, where the value of T_{m cot,p} is determined using the Type 1 channel access parameters used to access channel cⱼ. This disclosure describes the concept of multi-channel COT and, respectively, multi-channel COT sharing. Like in a single channel COT, the present disclosure defines a multi-channel COT, which consists of consecutive transmissions in the same multi-channels, where the transmissions are separated by gaps no larger than 25 μsec. To initiate a multi-channel COT, Type 1 channel access should be performed in each of the channels prior to the initial transmission. Then a COT sharing may be considered in each of the channels (RB sets), as in FIG. 9.

FIG. 9 illustrates an example of multi-channel channel occupancy time (COT) and channel occupancy time (COT) sharing according to an embodiment of the disclosure. In FIG. 9, multiple channel transmissions for five UEs (UE 1-UE5) are shown separated by gaps less than or equal to 25 μsec. In one embodiment, the gaps between channel transmissions may not be aligned in time if the gap in each channel is less or equal to 25 μsec. In an alternate embodiment, the gaps may be aligned. To this end, the UEs may use cyclic prefix extension (CPE) to may sure that gaps are aligned.

A first channel transmission (top row) comprises an LBT Type 1 period, a sidelink (SL) UE1 channel transmission period, a sidelink (SL) UE2 channel transmission period, and a sidelink (SL) UE3 channel transmission period. A second channel transmission comprises an LBT Type 1 period, a sidelink (SL) UE1 channel transmission period, a sidelink (SL) UE2 channel transmission period, and a sidelink (SL) UE5 channel transmission period. A third channel transmission comprises an LBT Type 1 period, a sidelink (SL) UE1 channel transmission period, a sidelink (SL) UE2 channel transmission period, and a sidelink (SL) UE4 channel transmission period. A fourth channel transmission (top row) comprises an LBT Type 1 period, a sidelink (SL) UE1 channel transmission period, a sidelink (SL) UE2 channel transmission period, and a sidelink (SL) UE4 channel transmission period.

In order to start and share a COT, the COT initiator transmits, after using Type 1 channel access in each channel, a multi-channel transmission, which includes the necessary info for COT sharing. During a multi-channel COT, multi-channel transmissions originated from UEs sharing the COT may take place in any subset of channels as long the definition is respected. The maximum duration is defined by the CAPC used for the first multi-channel transmission. The COT sharing may be a COT sharing in each individual channel, while respecting gap conditions. The COT sharing may be dedicated only to multi-channel transmissions, where the transmissions from a UE sharing the multi-channel COT may only be in the same set of channels where COT was initiated. COT sharing information is provided on each channel. PSFCH is provided in each channel carrying HARQ corresponding to that channel.

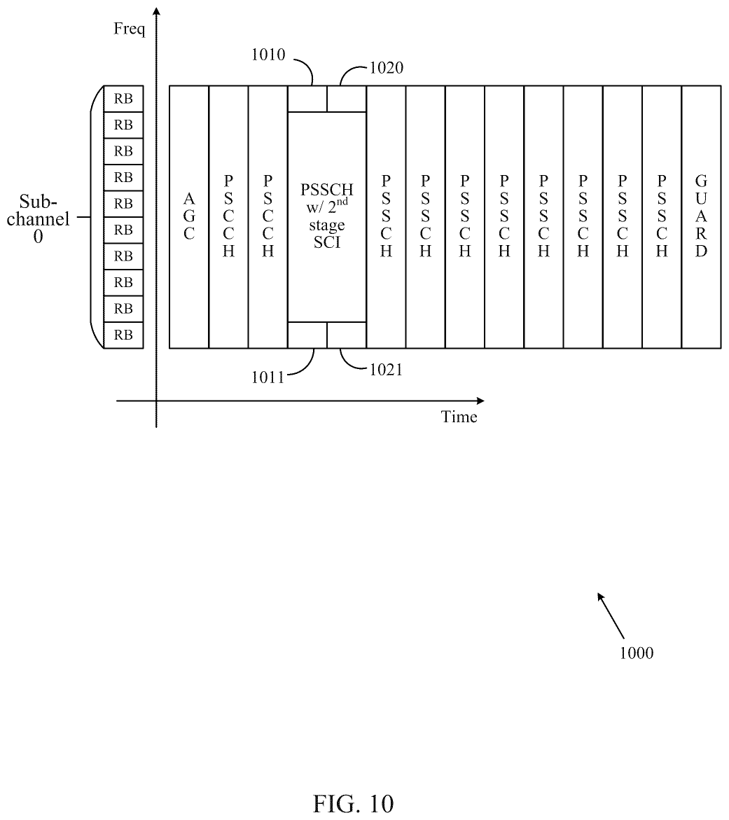

FIG. 10 shows an example of a frame structure 1000 for sidelink New Radio (SL NR) mode 2 according to an embodiment of the disclosure. In the 14-symbol slot, the subchannel 0 size is 10 resource blocks (RBs). There are a number of possible subchannel sizes. Following an AGC region, there is a PSCCH region that includes a first stage SCI (not shown) and a second stage SCI carried in resources of the PSSCH region. The resource blocks 1010, 1011, 1020 and 1021 are part of the PSSCH. There are PSSCH resource elements (Res) carrying DMRS and possibly CSI, but not shown. The final region is a guard region.

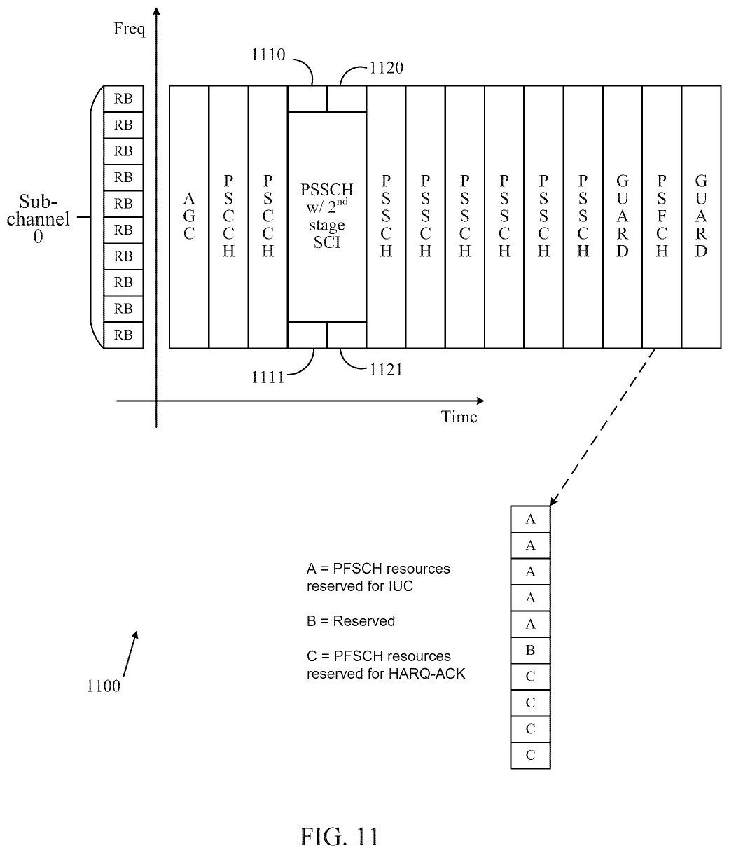

FIG. 11 shows an example of a frame structure 1100 for sidelink New Radio (SL NR) mode 2 where PSFCH is configured according to an embodiment of the disclosure. Frame structure 1100 is similar to the slot structure 1000 in FIG. 10, except that the last two symbols of the PSSCH region are used for guard and PSFCH. In this example, the PSFCH is (pre-) configured to support HARQ-ACK and IUC (inter-UE coordination) signals according to the legend in FIG. 11. The resources for HARQ-ACK and IUC are individually configured and each may span more than one subchannel.

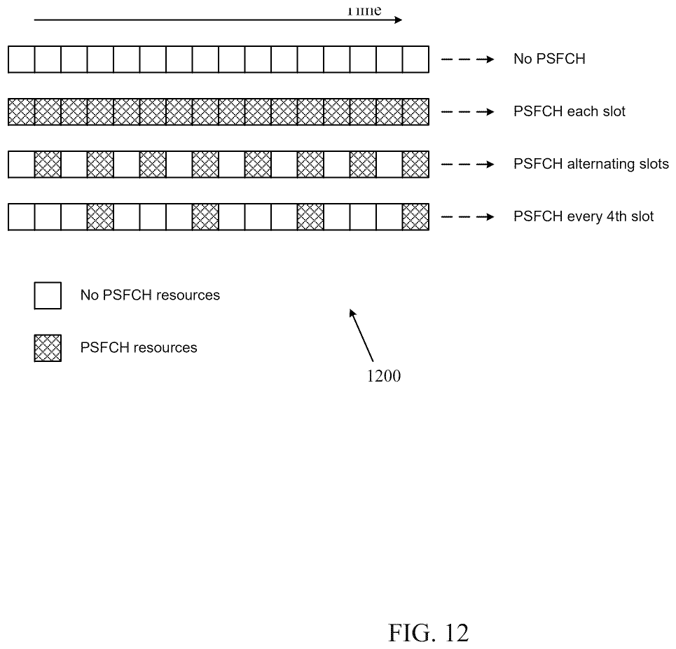

FIG. 12 illustrates the periodicity 1200 of PSFCH according to an embodiment of the disclosure. In FIG. 12, PSFCH resources are shaded. FIG. 12 illustrates i) PSFCH when disabled (No PSFCH), ii) PSFCH in each slot every slot, iii) PSFCH in every other slot, and iv) PSFCH in every fourth slot.

For co-channel coexistence in Rel-18, dynamic resource pool sharing is provided with the following constraints. For NR PSFCH (if configured), at least the following alternatives are supported: i) Alternative 1—avoid PSFCH transmission in time slots that overlap with subframes used for LTE SL transmissions. FFS: avoiding PSFCH transmissions can be performed by the UE transmitting PSFCH and/or the UE transmitting PSSCH; and ii) Alternative 2-NR SL UEs use a periodically repeating set of PSFCH slots. FFS: periodicities of the set.

In Alternative 1, the NR SL UE may avoid PSFCH transmissions in time slots that overlap with subframes used for LTE SL transmissions. In the case of a TX UE performing this action, while selecting resources for a transmission with HARQ enabled, the TX UE ensures that the time slot for PSCCH/PSSCH transmission as well as the time slot used for the feedback from the RX UE are available and not used by LTE SL UEs. In the case of an RX UE performing this action, the RX UE would simply not transmit on the PSFCH of a time slot if it overlaps with an LTE SL transmission, based on the LTE sensing information.

In Alternative 2, the NR SL UE may transmit PSFCH only in time slots that are a subset of the full set of periodic PSFCH enabled time slots. This subset is referred to as a basic resource set, which is then repeated over time. The advantage of using such a subset of PSFCH time slots is that when the LTE SL UEs perform SL RSSI measurements, a high RSSI may be detected on these subframes and would thereby be avoided for their own transmissions.

In the present disclosure, the following terminology may be used:
i) Legacy devices NR, which does not support the capability of coexistence).
ii) LTE legacy devices may use RSSI to avoid occupied resources. Therefore, the stronger the RSSI the more likely those resources will not be used by LTE.
iii) Legacy devices are provisioned with a single PSFCH occasion period of 1, 2, or 4 which they use to send the HARQ feedback.

In Alternative 1, the NR TX UE cannot avoid LTE resource reservations that occur after PSCCH/PSSCH, but before the PSFCH, or from LTE hidden from it, but not the RX UE that transmits PSFCH. There is too much impact to the NR system when the (pre-) configured PSFCH resources are not used by NR users and PSFCH slots may often have at least one LTE user. The impact to groupcast operation from dropping (ACK/)NACK or specification/backward compatibility from postponing (ACK/)NACK.

In alternative 2, the LTE RSSI measurements may not reliably cause all legacy LTE devices to avoid NR PSFCH, particularly in slots that only have NR PSFCH and not PSCCH/PSSCH. There is an impact to LTE performance from using the overlapping resources. The performance of NR is unclear as the number of NR UEs increases.

It is noted that Alternative 2 prevents the use of possible PSFCH slots from NR users, which will impact NR performance-especially as the number of NR users increases. The slots not in the periodic set cannot be used by NR PSFCH even when LTE is not present. Also, Alternative 2 does not help LTE when there are also legacy NR UEs in the same pool, a requirement of the WID.

Similar PSFCH resource utilization as the Alt 2 periodic set may be obtained with the introduction of additional periodicities, such as 5 and/or 10 (which also divide into 20). Given the large specification impacts and backward compatibility issues, new postponing behavior or the new periodic basic set operation are unlikely to be implemented. The present disclosure provides a new solution for LTE and NR sidelink coexistence different than Alternatives 1 and 2.

The disclosure provides a method for coexistence. In the proposed method, an additional (second) PSFCH period is configured to identify PSFCH slots where a dynamic coexistence is applied. In those PSFCH slots corresponding to the second period, the transmission of PSFCH may be dropped or postponed when a collision with LTE transmission is detected. When a SL UE with the new feature has to send PSCCH/PSSCH, which corresponds to a second PSFCH period, the SL UE may postpone the transmission if there is a PSFCH collision with LTE.

In the proposed method, the first PSFCH period corresponds to the legacy PSFCH resources that are used by the legacy devices. On those resources, the PSFCH transmissions are pursued even if a SL LTE and SL NR collision is identified. For example, a 2 slot sl-PSFCH-Period is configured and a new 4 slot sl-PSFCH-Period-Coex is configured. The PSFCH transmissions on the sl-PSFCH-Period are not dropped or postponed, despite possible conflict with LTE scheduling. Due to periodic transmissions (higher RSSI) LTE schedulers may avoid scheduling LTE SL transmission in this period. The transmissions on sl-PSFCH-Period-Coex period may be dropped and postponed for coexistence purposes. This period in time may have an increase of LTE transmissions, which will not perceive it as strong RSSI period.

For the particular example, every other PSFCH resource is preserved and cannot be dropped due to coexistence and every other PSFCH resource may be dropped for coexistence purposes. Additional periods may be defined for Rel-18 such as 8, which would allow, for example, a 4 slot sl-PSFCH-Period and an 8 slot sl-PSFCH-Period-Coex. Allowing sl-PSFCH-Period to equal sl-PSFCH-Period-Coex would cause Alternative 1 avoiding behavior all of the time, an alternative to making sl-PSFCH-Period-Coex optional. If the addition period is instead defined as the protected slots where Alt 1 avoiding behavior is not performed, sl-PSFCH-Period equaling sl-PSFCH-Period-Coex may have to be disallowed.

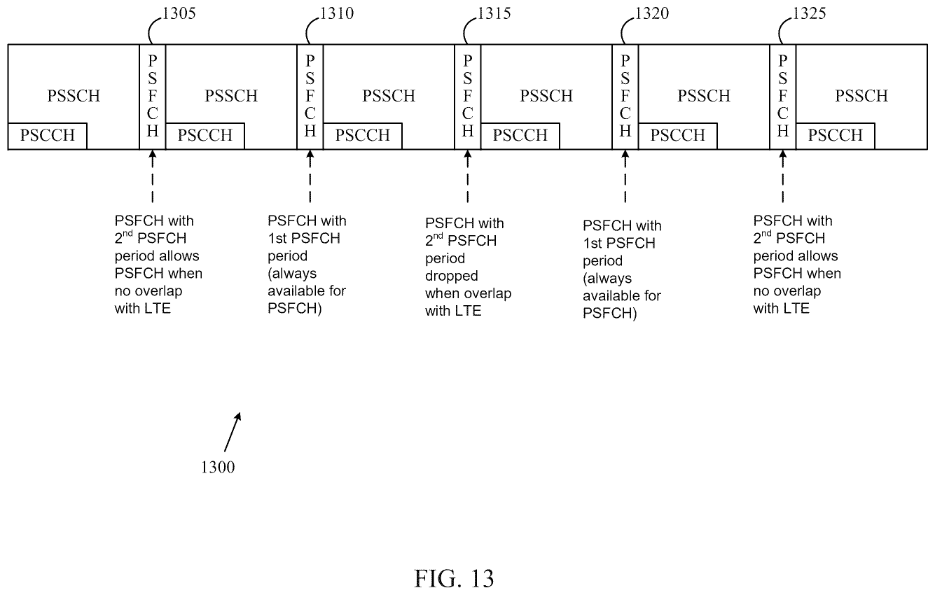

FIG. 13 illustrates PSFCH coexistence 1300 according to an embodiment of the disclosure. PSFCH 1305 comprises a PSFCH period that occurs with a 2^{nd} PSFCH period that allows the PSFCH 1305 when there is no overlap with LTE. PSFCH 1310 comprises a PSFCH period that occurs with a 1st PSFCH period, which is always available for a PSFCH. PSFCH 1315 comprises a PSFCH period with a 2^{nd} PSFCH period that is dropped when there is overlap with LTE. PSFCH 1320 comprises a PSFCH period that occurs with a 1st PSFCH period, which is always available for a PSFCH. Finally, PSFCH 1325 comprises a PSFCH period wherein a 2^{nd} PSFCH period allows the PSFCH 1325 when there is no overlap with LTE.

The second PSFCH period may be (pre-)configured and a multiple of the first PSFCH period. Viewed as a set, in this embodiment, the slots where coexistence may be performed are a subset of the set of total PSFCH slots. If a PSFCH slot is in this subset, coexistence may be performed. Otherwise, the PSFCH slot may always be used. In an alternate embodiment, the periods may also be the same, in which case coexistence with LTE is always performed unless the periods are offset. Viewed as a set, in the embodiment with the same period and an offset, the sets are non-overlapping. All PSFCH occasions either belong to the protected set or the coexistence set. If the period is known to be the same, only the offset (or delay) needs to be (pre-) configured or dynamically signaled.

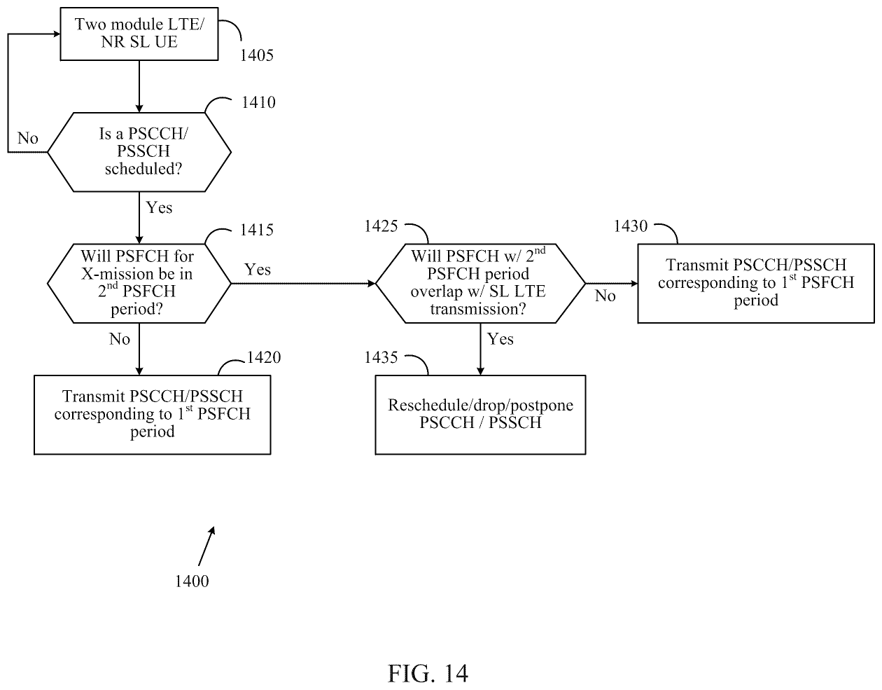

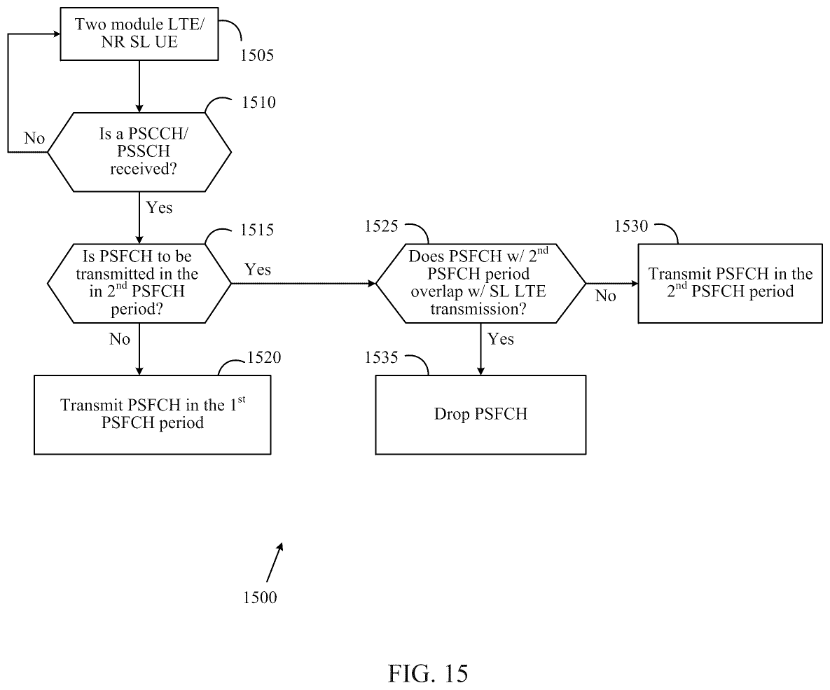

In an alternate embodiment, the operations are described in terms of sets or protected (no coexistence) for Rel-18 UE supporting the coexistence feature. If the sets are overlapping, for the overlapped slots the order of checking is important. For example, the flowcharts in FIGS. 14 and 15 first check whether coexistence is to be performed, but alternatively can check whether the PSFCH is protected. As long as the order of checking is established, there is no particular restriction on the value of the periods or sizes of the sets. The enabling and disabling of the second PSFCH period may be signaled via DCI, MAC-CE or RRC commands, (either from gNB or from another UE). Each PSFCH slot may correspond to one or more than one PSCCH/PSSCH transmission.

FIG. 14 is a flowchart 1400 depicting an example of NR SL UE coexistence in which data (PSCCH/PSSCH) is transmitted (i.e., receiving PSFCH) according to an embodiment of the invention. In step 1405, an LTE/NR SL user equipment having two transceiver modules is configured to operate in both LTE and NR protocols. In 1410, the UE determines if a PSCCH or PSSCH is scheduled. If NO in step 1410, then the UE returns to step 1405 and continues to check to see if a PSCCH or PSSCH is scheduled. If YES in step 1410, then in step 1415, the UE determines if the PSFCH for the transmission will be in the 2^{nd} PSFCH period.

If NO in step 1415, then in step 1420, the UE will transmit the PSCCH/PSSCH corresponding to the 1st PSFCH period. If YES in step 1415, then in step 1425, the UE determines whether the PSFCH in the second PSFCH will overlap with the sidelink LTE transmission. If NO in step 1425, then in step 1430, the UE will transmit the PSCCH/PSSCH corresponding to the 1st PSFCH period. If YES in step 1425, then in step 1435, the UE will reschedule (or drop or postpone) the PSCCH or PSSCH.

FIG. 15 is a flowchart 1500 depicting an example of NR SL UE coexistence in which data (PSCCH/PSSCH) is received (i.e., sending PSFCH) according to an embodiment of the invention. In step 1505, an LTE/NR SL user equipment having two transceiver modules is configured to operate in both LTE and NR protocols. In 1510, the UE determines if a PSCCH or PSSCH has been received. If NO in step 1510, then the UE returns to step 1505 and continues to check to see if a PSCCH or PSSCH has been received. If YES in step 1510, then in step 1515, the UE determines if the PSFCH will be transmitted in the 2^{nd} PSFCH period.

If NO in step 1515, then in step 1520, the UE will transmit the PSFCH in the 1st PSFCH period. If YES in step 1515, then in step 1525, the UE determines whether the PSFCH in the second PSFCH period will overlap with the sidelink LTE transmission. If NO in step 1525, then in step 1530, the UE will transmit the PSFCH in the 2^{nd} PSFCH period. If YES in step 1525, then in step 1535, the UE drop the PSFCH.

Handling single module NR SL UE—In a different embodiment, a SL UE that comprises two (dual) modules LTE and NR may exchange capability information with other UEs that support only NR modules. In such an embodiment, the dual module UE supports signaling to single module UE (for instance IUC like) of the contention between PSFCH opportunities and LTE transmissions and indicates to the second UE (single modules) the extra opportunities for PSFCH transmissions.

The present disclosure provides a method that may be used to deal with LBT failures for SL-U PSFCH. In this embodiment, a SL-U is configured with two sets or two periods of PSFCH opportunities. A first set of fixed PSFCH configured transmission opportunities comprising at least one opportunity per PSCCH/PSSCH transmission is provided. A second set of PSFCH configured transmission opportunities that can be enabled or disabled and that can be periodic or single shot with respect to a PSCCH/PSSCH transmission also is provided. The second set may be enabled or disabled via dynamic indication in SCI, or via MAC CE or PC5_RRC. The enablement may be for the entire second set or a subset of the second set which may be indicated via a bitmap.

In this embodiment, the enablement of the second set may be done after a failure to receive PSFCH in the first set or after multiple failures of receiving PSFCH in the first set (periods). Both first PSFCH set (periods) and second PSFCH set (periods) may be configured and respectively second set enabled at the corresponding PSCCH/PSFCH transmission.

A similar embodiment may be used for the groupcast transmissions, either NACK-only, or ACK-only or ACK/NACK feedback. For the groupcast, the feedback (ACK-only, NACK-only, or ACK-NACK) is indicated either dynamically or via configuration. Similarly, the feedback PSFCH opportunities first PSFCH occasions set (or first periodicity) and second PSFCH occasions set (second periodicity) may be indicated either via dynamic SCI, MAC-CE or RRC. In a different embodiment, the indication of the PSFCH opportunities is not explicitly provided but is based on a rule which may be a priori (pre-) configured. For instance, for ACK-only use, only the first set, for NACK-only, may use the first and the second set of PSFCH opportunities.

For dynamic mode, when LTE coexistence is detected, the NR module starts a timer (e.g. number of slots). When the NR device is to transmit, it disables the HARQ-ACK feedback and the device may resort to a fixed number of transmissions for each packet. The timer may be updated. If there is no LTE coexistence, there is a timer check. If the timer has expired, the NR device may enable HARQ-ACK feedback. Otherwise, the NR device continues disabling HARQ feedback.

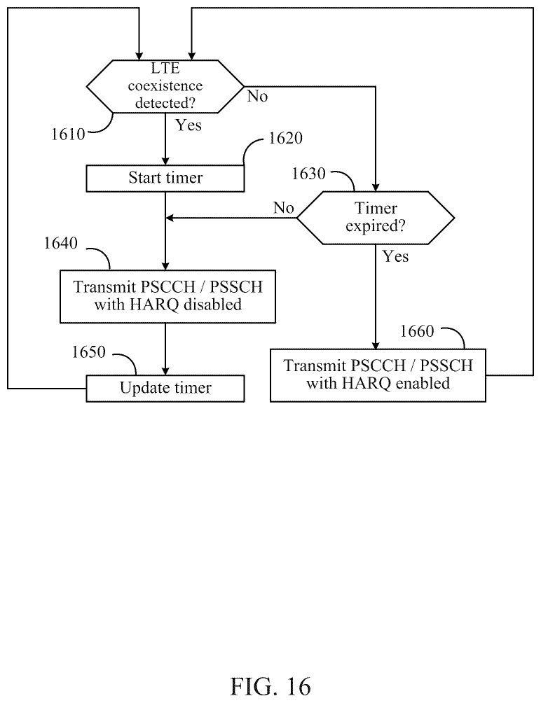

FIG. 16 is a flowchart 1600 illustrating an example of PFSCH periodicity according to an embodiment of the present disclosure. In step 1610, the UE determines if LTE coexistence has been detected. If YES in step 1610, then in step 1620, the UE starts a timer and proceeds to step 1640. If NO in step 1610, then in step 1630, the UE determines if the timer has expired. If NO in step 1630, then the UE proceeds to step 1640. If YES in step 1630, then the UE transmits the PSCCH or PSSCH with HARQ enabled and then returns to step 1620. In step 1640, the UE transmits the PSCCH or PSSCH with HARQ disabled. In step 1650, the UE updates the timer and then returns to step 1620.

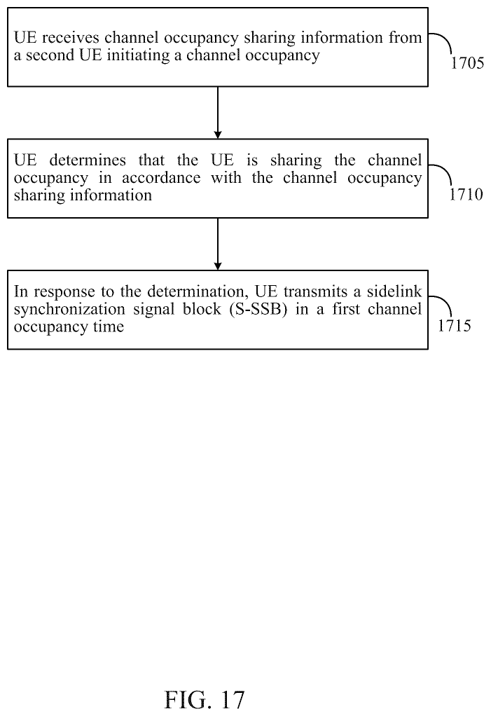

FIG. 17 is a flowchart illustrating an example of sidelink synchronization signal block (S-SSB) transmission flow according to an embodiment of the present disclosure. In 1705, a UE receives channel occupancy sharing information from a second UE initiating a channel occupancy. The channel occupancy sharing information includes a remaining channel occupancy duration and one or more identities of one or more UEs. In 1710, the UE determines that the UE is sharing the channel occupancy in accordance with the channel occupancy sharing information. In 1715, in response to the determination, the UE transmits a sidelink synchronization signal block (S-SSB) in a first channel occupancy time.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method implemented by a user equipment (UE), comprising:
determining whether a time to transmit a sidelink synchronization signal block (S-SSB) has been reached;
determining whether a first channel occupancy time is in progress; and
in response to a determination that the first channel occupancy time is not in progress, transmitting the S-SSB without the first channel occupancy time sharing channel access.

2. The method of claim 1, further comprising:
in response to a determination that the first channel occupancy time is in progress, determining whether the UE is sharing the first channel occupancy time with a second UE; and
in response to a determination that the UE is not sharing the channel occupancy time with the second UE, transmitting the S-SSB without the first channel occupancy time sharing channel access.

3. The method of claim 1, further comprising:
in response to a determination that the UE is sharing the first channel occupancy time with a second UE, determining whether the UE is allowed to transmit the S-SSB in the first channel occupancy time.

4. The method of claim 1, further comprising:
in response to a determination that the UE is allowed to transmit the S-SSB in the first channel occupancy time, transmitting the S-SSB using the first channel occupancy time sharing channel access.

5. The method of claim 1, further comprising:
in response to a determination that the UE is not allowed to transmit the S-SSB in the first channel occupancy time, cancelling transmission of the S-SSB.

6. A user equipment (UE), comprising:
one or more processors; and
a non-transitory memory storing programing instructions that, when executed by the one or more processors, cause the user equipment to:
determine whether a time to transmit a sidelink synchronization signal block (S-SSB) has been reached;
determine whether a first channel occupancy time is in progress; and
in response to a determination that the first channel occupancy time is not in progress, transmitting the S-SSB without the first channel occupancy time sharing channel access.

7. The user equipment of claim 6, wherein the programing instructions, when executed by the one or more processors, further cause the user equipment to:
in response to a determination that the first channel occupancy time is in progress, determine whether the user equipment is sharing the first channel occupancy time with a second UE; and
in response to a determination that the UE is not sharing the channel occupancy time with the second UE, transmit the S-SSB without the first channel occupancy time sharing channel access.

8. The user equipment of claim 6, wherein the programing instructions, when executed by the one or more processors, further cause the user equipment to:
in response to a determination that the UE is sharing the first channel occupancy time with a second UE, determine whether the UE is allowed to transmit the S-SSB in the first channel occupancy time.

9. The user equipment of claim 6, wherein the programing instructions, when executed by the one or more processors, further cause the user equipment to:
in response to a determination that the UE is allowed to transmit the S-SSB in the first channel occupancy time, transmit by the UE the S-SSB using the first channel occupancy time sharing channel access.

10. The user equipment of claim 6, wherein the programing instructions, when executed by the one or more processors, further cause the user equipment to:
in response to a determination that the UE is not allowed to transmit the S-SSB in the first channel occupancy time, cancel transmission of the S-SSB.

11. A user equipment (UE), comprising:
one or more processors; and
a non-transitory memory storing programing instructions that, when executed by the one or more processors, cause the UE to:
determine whether a first channel occupancy time is in progress;
in response to a determination that a first channel occupancy time is not in progress, use a physical sidelink feedback channel (PSFCH) occasion configured by a data transmitter outside a first channel occupancy time access to transmit the PSFCH resource blocks; and
in response to a determination that the first channel occupancy time is in progress, determine whether the UE is sharing the first channel occupancy time with a second UE.

12. The user equipment of claim 11, wherein the programing instructions, when executed by the one or more processors, further cause the user equipment to:
in response to a determination that the UE is not sharing the first channel occupancy time with a second UE, using a PSFCH occasion configured by the data transmitter outside the first channel occupancy time access to transmit the PSFCH resource blocks.

13. The user equipment of claim 11, wherein the programing instructions, when executed by the one or more processors, further cause the user equipment to:
in response to a determination that the UE is sharing the first channel occupancy time with the second UE, using a PSFCH occasion configured by the data transmitter inside the first channel occupancy time access to transmit the PSFCH resource blocks.

14. The user equipment of claim 11, wherein the programing instructions, when executed by the processor, further cause the user equipment to:
perform Listen Before Talk (LBT) channel sensing on at least one default PSFCH occasion.

15. The user equipment of claim 14, wherein the programing instructions, when executed by the processor, further cause the user equipment to:
determine whether the Listen Before Talk (LBT) channel sensing failed.

16. The user equipment of claim 15, wherein the programing instructions, when executed by the processor, further cause the user equipment to:
in response to a determination that the LBT channel sensing did not fail, transmit the PSFCH resource blocks.

17. The user equipment of claim 15, wherein the programing instructions, when executed by the processor, further cause the user equipment to:
in response to a determination that the LBT channel sensing failed, perform LBT channel sensing on another PSFCH occasion.

18. The user equipment of claim 17, wherein the programing instructions, when executed by the processor, further cause the user equipment to:
transmit the PSFCH resource blocks after a successful LBT on additional PSFCH occasions.

19. The user equipment of claim 15, wherein the programing instructions, when executed by the processor, further cause the user equipment to:
continuously transmit without another LBT procedure for a maximum channel occupancy time (COT).

20. The user equipment of claim 15, wherein the COT is based on a channel access priority class (CAPC) that is signaled to UE.
